(19) United States
(12) Patent Application Publication
(10) Pub. No.: US 2006/0235786 A1
(43) Pub. Date: Oct. 19, 2006

(54) System and method for securities liquidity flow tracking, display and trading

(76) Inventor: Dean DiSalvo, Satellite Beach, FL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 11/106,423

(22) Filed: Apr. 14, 2005

(51) Int. Cl. G06Q 40/00

(52) U.S. Cl. 705/37

(57) ABSTRACT

A method, system and computer program that receives, processes, and displays level one, level two, and time and sales securities data. Through a variety of charts, the data is analyzed to identify liquidity trade imbalances and trends in trading liquidity. A logic based trading algorithm utilizes the current market maker activity information and the historical liquidity tiers to execute trades automatically.

### RELATED APPLICATION DATA

None.

### TECHNICAL FIELD

The invention relates generally to securities trading methodologies and more specifically to a real-time monitoring and historical analysis of securities market activity and liquidity flow for several securities simultaneously.

### BACKGROUND OF THE PRESENT INVENTION

In a securities market, shares of stock in corporations and options thereon, commodity futures and options thereon, currencies and the like are traded over a common system or exchange. Other traded items can include, but are not limited to, indices and mutual funds. For simplicity, however, the following discussion is limited to the purchase and sale of corporate stock, although the teachings of the present invention are not limited thereto and can be applied to all types of securities. Within the exchange, traders buy and sell securities using bids and offers also referred to as asks. More specifically, market makers who are selling securities transmit “offers” or prices and volumes at which they will sell vanous securities. Market makers who are buying securities transmit “bids” or prices and volumes at which they will buy various securities. Sellers attempt to sell at the highest possible price and buyers attempt to buy at the lowest possible price. The “inside market” represents the best price for sellers and buyers, and respectively is comprised of the lowest ask also known as the inside ask price or level one ask and the highest bid also known as the inside bid price or level one bid.

To maximize the profit taken from the securities market, traders desire certain information to determine when it is most advantageous to sell or buy a particular security. Traditionally, traders have tracked information derived from the “floor” of exchanges such as the New York Stock Exchange (NYSE), the National Association of Securities Dealers (NASDAQ), the Chicago Mercantile Exchange and the like. This information can be transmitted electronically in near real-time i.e., almost simultaneously with actual market activity, to computer workstations for traders to view and analyze in conjunction with buying and selling securities.

The information presently available to traders includes “level one” information and “level two” information. Level one information for a particular security typically includes, but is not limited to, the current trade value i.e., last trade, the current trade volume, the total volume of shares traded during the trading session, the price to earnings (PIE) ratio, the previous trading day's closing value, the present day's opening value, the high and low values for the day and for the previous 52 weeks, the change from the prior closing value, the lowest ask inside ask, the highest bid inside bid, the earnings per share, the market capitalization, the dividend paid per share, the dividend yield, news items and articles, and so forth. Also available are records of historical performance, which can be displayed graphically on a trade by trade basis or over periods of time ranging from fractions of seconds to years. Also available are statistics for an entire exchange, such as total volume of shares traded and statistics for calculated market indices, such as the Dow-Jones Industrial Average “The DOW”, the NASDAQ Composite, the Standard & Poor's 500 “S&P 500”, the Russell 2000, sector indices, etc.

Level two information for a particular security typically includes each market maker having an open or active bid or ask, the time when the bid or ask was placed, also referred to respectively as bid time and ask time, size or volume of the bid or ask i.e., number of shares (often reported in lots of 100) and the bid or ask price.

Many traders are interested in short term upward or downward price movements for selected securities. Upward and downward price movement can be predicted by observing level two information for trends of market makers as they offer and bid shares of various securities. Typically, the trader uses a computer monitor to display level two information for a few securities (for example, from one to three securities). The number of securities that can track from the displayed data is limited by the individual's memory capacity and cognitive ability. Obviously, it is impossible for a trader to assimilate tens or hundreds of dynamically updated informational items per security per second. As a result, most traders can effectively track only a few securities at a time. Skilled traders may be able to track several securities. Nevertheless, this technique is physically and mentally taxing on the trader. In addition, while a trader is tracking one or two securities, a purchase or sell opportunity for a different, untracked security may be missed.

At least one attempt to automate the analysis of level two information has been made. As discussed in U.S. Pat. No. 5,297,032, market depth for a watch list of securities is displayed by identifying the total number of market makers on the inside market for respective bid and offer quotes for each watch list security, along with arrows to indicate whether the number of market makers at these prices is increasing, constant or decreasing. However, this system may not provide adequate or sufficient information for a trader to make a confident decision as to the appropriateness of purchasing or selling a particular security.

Accordingly, there exists a need in the art for a more sophisticated securities and market maker activity tracking system than the prior art provides.

### SUMMARY OF THE INVENTION

One embodiment of the present invention comprises a method for performing liquidity flow analysis for a security. The method further comprises receiving trading data associated with the security, wherein the trading data comprises trading data for a plurality of buyers and sellers; defining display parameters for the trading data; displaying elements of the trading data in accordance with the defined display parameters; defining analysis parameters for the trading data; aggregating the trading data for the plurality of buyers and sellers for the security and analyzing the trading data according to the analysis parameters to determine whether the security exhibits a liquidity flow imbalance. According to another embodiment, the invention comprises a computer program product for performing liquidity flow analysis for a security, the computer program comprising: a computer usable medium having computer readable program code modules embodied in the medium for performing the liquidity flow analysis; a computer readable first program code module for receiving trading data associated with the security wherein the trading data comprises over a predetermined time interval, bid prices and an associated bid volume and ask prices and an associated ask price volume; a computer readable second program code module for assigning each bid price to an appropriate bid price tier from among a plurality of bid price tiers; a computer readable third program code module for assigning each ask price to an appropriate ask price tier from among a plurality of ask price tiers; a computer readable fourth program code module for displaying a plurality of first elements each representing one of the plurality of bid price tiers and a bid price volume associated therewith; a compute readable fifth program code module for displaying a plurality of second elements each representing one of the plurality of ask price tiers and an ask price volume associated therewith and a computer readable sixth program code module for analyzing the bid price volume for each one of the plurality of bid price tiers and the ask price volume for each one of the plurality of ask price tiers to determine whether the security exhibits a liquidity trade imbalance.

### BRIEF DESCRIPTION OF DRAWINGS

The present invention can be more easily understood and the advantages and uses thereof more readily apparent when the following detailed description of the present invention is read in conjunction with the figures wherein:

FIG. 1 is a block diagram of a securities and market maker activity tracking system according to the present invention;

FIG. 2 illustrates the MB Trading main control GUI window 089 with a “Liquidity Flow” 097 button added.

FIGS. 3A and 3B illustrate the control GUI dialog box for the liquidity charting, pattern analysis, simulated trading, and automated trading.

FIG. 4 illustrates a more detailed view of the control GUI dialog box with associated labels from FIG. 3.

FIG. 5 illustrates the display window for automated trade status and message update status.

FIG. 6 illustrates the MB Trading level 2 trade table.

FIG. 7 illustrates the chart hierarchy and various chart displays.

FIG. 8 illustrates a real-time chart that shows the real-time liquidity imbalance for several securities.

FIG. 9 illustrates a real-time chart that shows the liquidity flow for a security with price reaction across time (one hour in this example).

FIG. 10 illustrates a real-time chart that shows the price tier and volume for every market maker for each security.

FIG. 11 illustrates a real-time activity chart that shows the volume bias per price tier for every market maker for each security for a given window of time (thirty minutes in this example).

FIG. 12 illustrates a real-time chart that shows bid price, ask price, bid volume, and ask volume for a single market maker across time.

FIGS. 13A-13E are flowcharts that illustrate the data feed and process timers.

FIG. 14 is a flowchart that illustrates the trading process decisions.

FIG. 15 is a flowchart that illustrates the simulated trading process.

FIG. 16 is a flowchart that illustrates the trading algorithm pattern identification stages.

FIG. 17 illustrates a sample pattern definition table.

FIG. 18 illustrates a sample condition table.

FIG. 19 illustrates a sample algorithm table.

FIG. 20 illustrates a sample automated algorithm creation form.

Reference characters denote like elements throughout the figures and text.

### DETAILED DESCRIPTION OF THE INVENTION

In the detailed description that follows, identical components have been given the same reference numerals in different embodiments of the present invention. To illustrate the present invention in a clear and concise manner, the drawings may not necessarily be to scale and certain features may be shown in somewhat schematic form. So as not to obscure the disclosure with details that will be readily apparent to those skilled in the art, certain conventional elements and steps have been presented with lesser detail, while the drawings and the specification describe in greater detail other elements and steps pertinent to understanding the invention.

The present invention relates to systems and associated methods of displaying, tracking and analyzing securities traded over a common market. The systems and associated methods assist a user to track and analyze the activity of market makers involved in the purchase and sale of the traded securities. In doing so, the systems and associated methods identify market maker activity trends, or indicators, potentially leading to short term (i.e., a limited duration of time, for example, between several seconds to perhaps as long a several hours) upward or downward price movement in a security. The systems and methods use sets of dynamically updated information elements relating to market maker activity and statistics derived therefrom to present the user with information regarding the activity of market makers involved in the purchase and sale of the traded securities.

According to one aspect of the invention, a method of tracking activity of a plurality of market makers relating to securities traded on at least one common exchange where the market makers place bids and asks. The method includes receiving a dynamically updated data stream containing level one and level two data related to a plurality of securities traded over at least one exchange, the level one data comprising at least the last trade price, the best bid price, and the best ask price of each security and the level two data comprising a bid price, a bid time, a bid volume, a security identifier, and a market maker identifier for each bid, and an ask price, an ask volume, an ask time, a security identifier and a market maker identifier for each ask for a selected security.

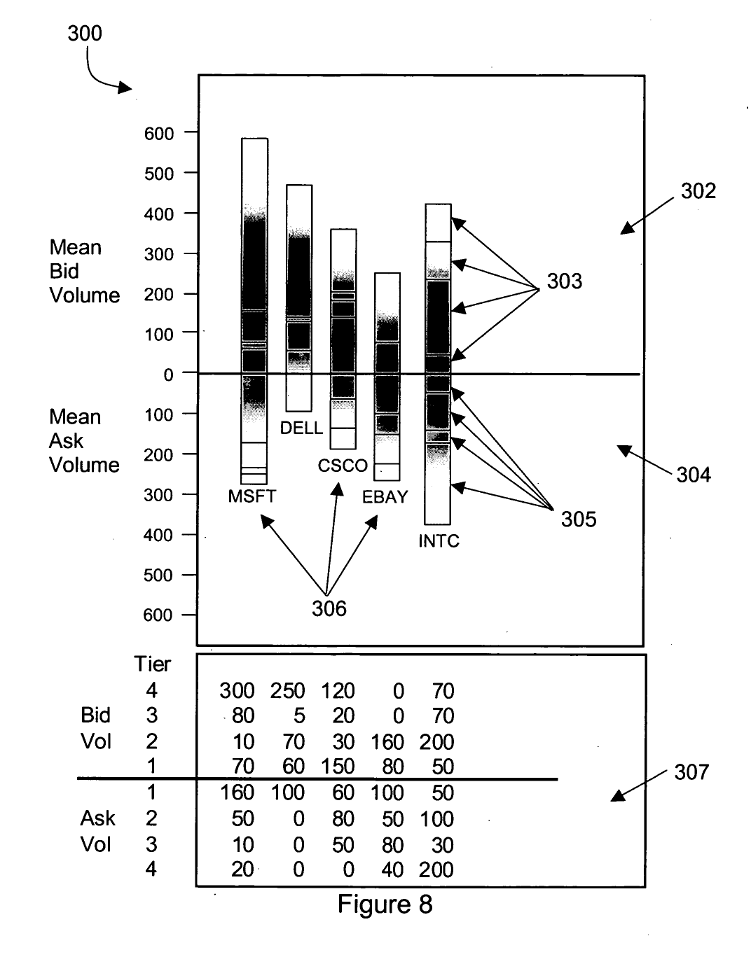

The current art provides tables, charts, and automated trading based on a real-time snapshot of the level two data. Traditionally, a trader uses his/her experience and memory to recognize a favorable pattern and place a trade when that pattern is identified. A method that allows the trader to view the liquidity imbalance (also referred to as the liquidity trade imbalance or the liquidity flow imbalance) of several securities at once, according to the teachings of the present invention and as illustrated in FIG. 8, is an improvement to the current art. The invention is further advantageous in that it allows for the aggregation of the level one, level two and time and sales data across a plurality of market makers and ECN'S.

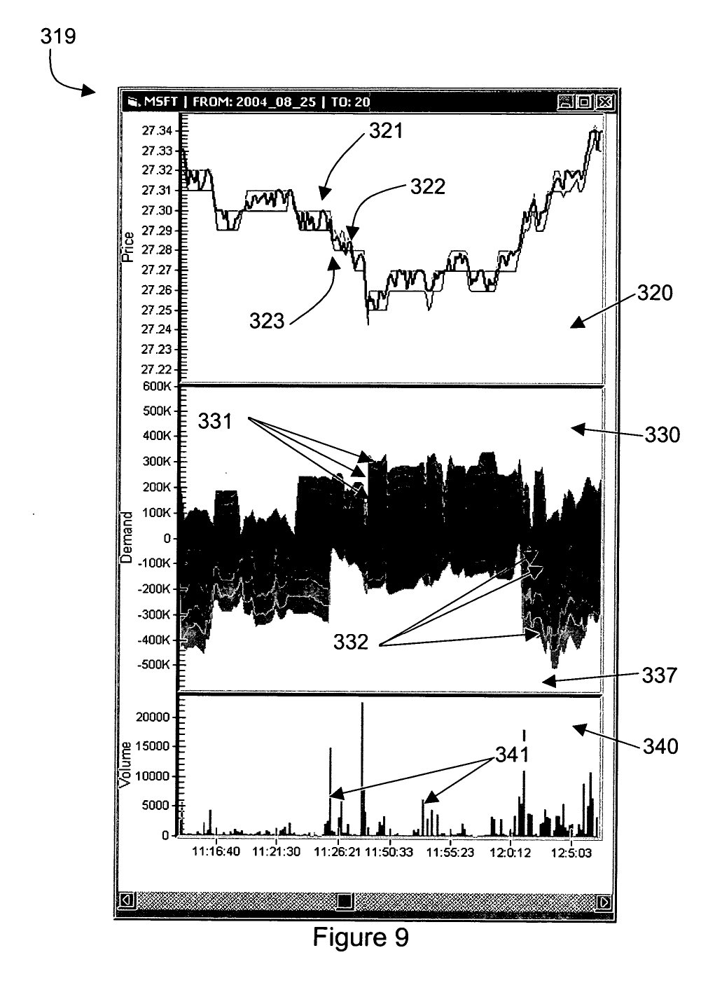

The current art further provides tables, charts, and automated trading based on a real-time snapshot of the level one, level two, and time and sales data. Viewing only a real-time snapshot fails to show the relationship between the level two data and the resulting price change. According to one embodiment of the present invention as illustrated in FIG. 9, an historical chart showing the liquidity imbalance and trade price reaction, as a function of time, provides a greater insight into the understanding and analysis of market activities.

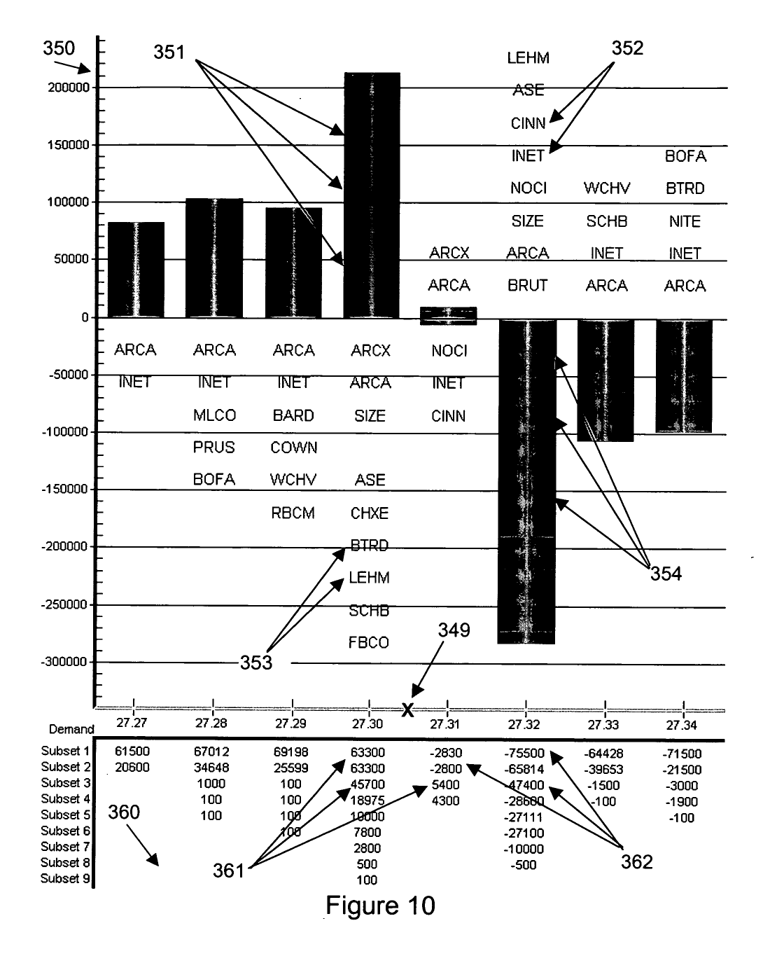

The current art provides a method for viewing real-time market maker liquidity. The current art fails to highlight the depth of the market imbalance. This invention provides an improved method of viewing the real-time market maker liquidity. As illustrated in FIG. 10, the chart has each market maker bid price and bid volume per price tier on a single positive axis, and each market maker ask price and ask volume per price tier on a single negative axis. Market imbalances, such as a crossed market, isolated pockets of liquidity and short-term price runs are quickly identified according to this method of viewing real-time market maker liquidity. For example, a large ramp up on the bid side for a few market makers with a large volume, indicates an increase in demand, which typically results in an increase in price.

A “price tier”, as defined in the invention, is based on the bid price and ask price. The first price tier is the best bid price and the best ask price. The second price tier is one cent below the best bid price and one cent above the best ask price. The tenth price tier is nine cents below the best bid price and nine cents above the best ask price.

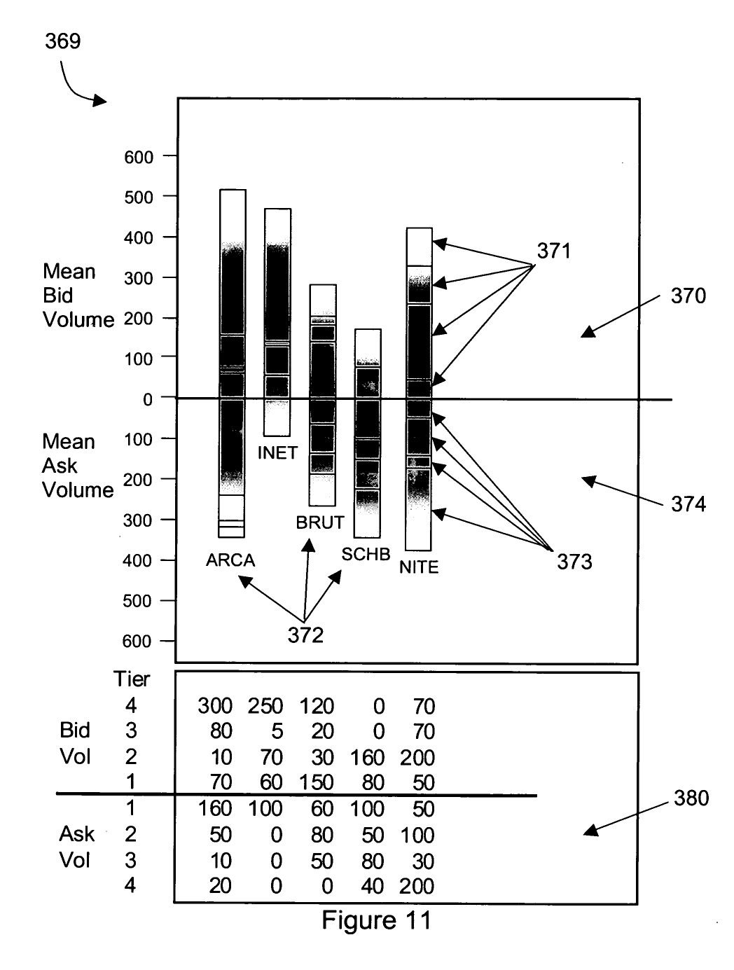

The current art attempts to identify market maker intentions by counting the number of times the market maker is on the “inside” market during a given time interval. Inside the market means the market maker has a bid or ask price at the best price. According to the teachings of the present invention, an improved method of identifying the market maker trading intentions, as illustrated in FIG. 11, is to view the volume for each market maker at each price tier for a given time window. Each market maker can be analyzed over a plurality of timeframes or windows to isolate short-term and long-term trading patterns.

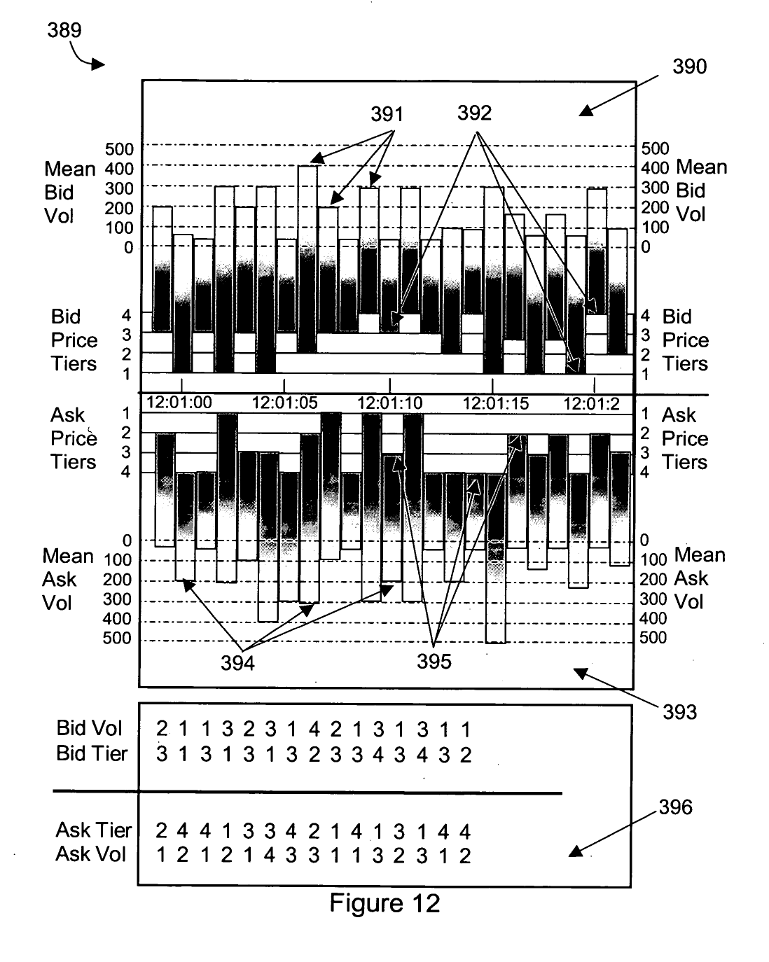

The current art provides tables, charts, and automated trading based on a real-time snapshot of the level one, level two, and time and sales data. The current art does not provide a method of viewing the historical bid price, bid volume, ask price, and ask volume for specific market maker. A chart that shows the market makers trading history across time is illustrated in FIG. 12. This method of charting provides a better depth and understanding of the market maker's true trading intentions.

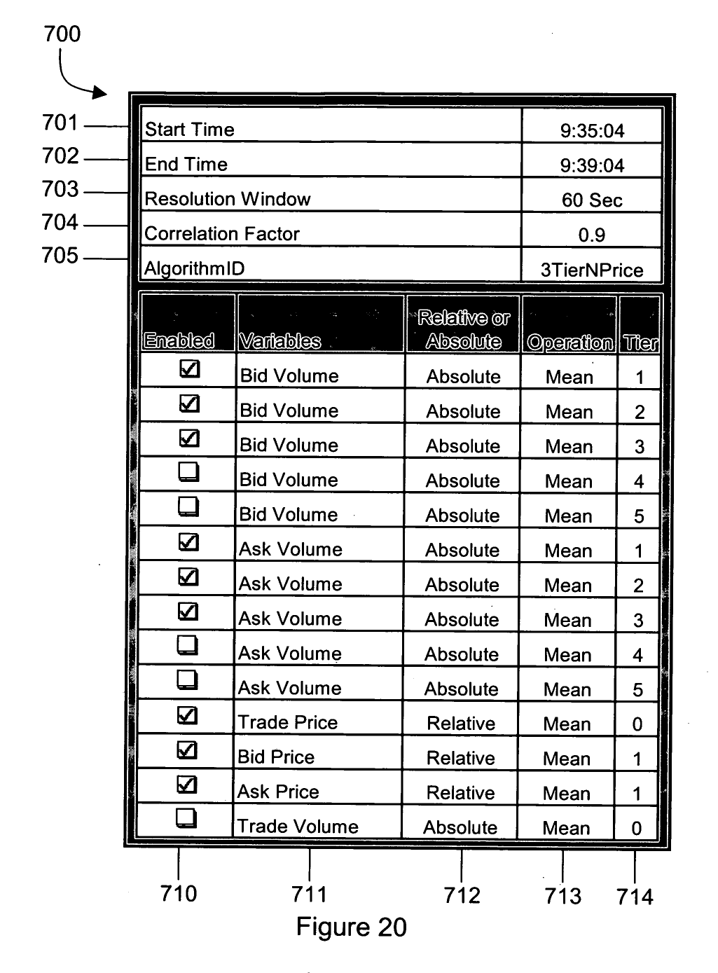

The present invention further comprises a method that allows the trader to specify favorable patterns in the level one, level two, and time and sales data. The pattern control variables can be defined either manually or automatically as illustrated in FIG. 20. Once the trading algorithm definitions are complete, the user can simulate trading with historical data, simulate trading with real-time data or perform automated trading, i.e., buying and selling of securities (all referred to as security transactions).

The information displayed to the user, including the calculated statistics, is dynamically sorted so that with each screen refresh, the displayed information is ordered appropriately according to the display method selected by the user.

Securities Liquidity Flow Tracking, Display and Trading System Overview

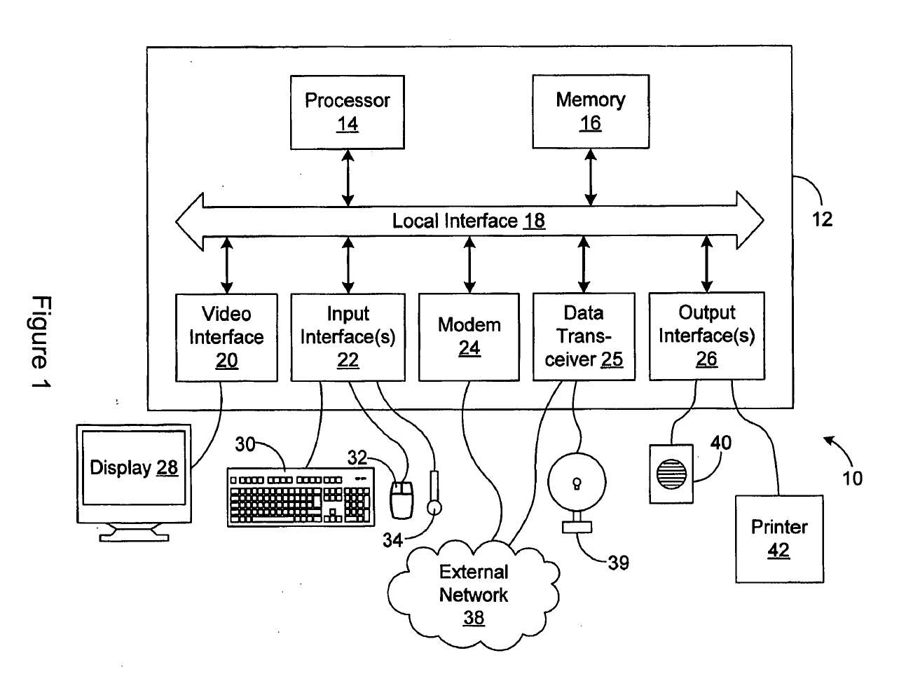

FIG. 1 illustrates a block diagram of a securities and market maker activity tracking system 10 embodying concepts of the present invention. As used herein, the term “security” or “securities” is intended to include, but is not limited to, shares of stocks in corporations or options thereon, corporate or government bonds, commodity futures or options thereon, currencies, options, indices, mutual funds and all other items traded over a common system or exchange. The term security can also include indices, such as for example, “the Dow”, “the NASDAQ composite”, a sector index or indicator and so forth. The term “symbol” or “symbols” includes securities and indices. Briefly, the system 10 is a data processor having a graphical user interface to assist a securities trader in analyzing information from security markets for opportune times to purchase or sell a particular security. Although the invention has application in tracking and analyzing securities of any type, the following discussion relates to the tracking and analysis of information related to the trading of shares of corporate stock on an exchange or exchanges, although the invention is not limited to the trading of corporate stock on an exchange.

More specifically, the activity of market makers i.e., placement of bids and asks is analyzed according to the present invention as described further below. Many of the described operational modes according to the present invention are intended to identify temporary, typically short term, i.e., lasting from several seconds to perhaps as long a several hours, imbalances in individual or collective market maker activity that can lead to a price change in a particular security or index. These imbalances are also referred to as upward or downward price pressures and may last for few seconds, minutes or hours depending on market conditions.

The system 10 includes a computer system 12, that in one embodiment includes multiple remotely located computers that communicate with the compute system 12 via known communications channels. However, in the illustrated exemplary embodiment of FIG. 1, the computer system 12 includes a single computer. The computer system 12 comprises one or more processors 14 for executing instructions, usually in the form of computer code, to carry out a specified logic routine. The computer system 12 further comprises a memory 16 for storing data, software, logic routine instructions, computer programs, data files, operating system instructions, and the like, as is well known in the art. The memory 16 comprises several devices, for example, volatile and non-volatile memory components. Volatile memory components typically do not retain data values upon a loss of power. Non-volatile memory components retain data upon a loss of power. Thus the memory 16 comprises, for example, random access memory RAM, read only memory ROM, hard disks, floppy disks, compact disks including, but not limited to, CD-ROM, DVD-ROM, and CD-RW, tapes, and/or other memory components, further comprising associated drives and players for these memory types. In a multiple-computer embodiment, the processor 14 can comprise multiple processors on one or more computer systems linked locally or remotely. According to one embodiment, the software of the present invention is segregated so that different software segments can be executed by different computers located locally or remotely from each other.

The processor 14 and the memory 16 are coupled to a local interface 18. The local interface 18 comprises, for example, a data bus with an accompanying control bus, or a network between a processor and/or processors and/or memory or memories. In various embodiments, the computer system 12 further comprises a video interface 20, one or more input interfaces 22, a modem 24 and/or a data transceiver interface device 25. The modem 24, the data receiver 25 and any other device for receiving and/or transmitting data are also referred to herein as a receiver, a receiving means and/or a transceiver. The computer system 12 further comprises a number of output interfaces 26 each being coupled to the local interface 18.

The system 10 further comprises a display 28 coupled to the local interface 18 via the video interface 20. Although shown as a single cathode ray tube CRT type display, multiple displays can be accommodated. Also, the display device can alternatively comprise, for example, a liquid crystal display LCD, a plasma display, an electro-luminescent display, indicator lights, or light emitting diodes LEDs. In other embodiments, the system 10 comprises several input devices including, but not limited to, a keyboard 30, a mouse 32, a microphone 34, a digital camera not shown and a scanner not shown, each being coupled to the local interface 18 via the input interfaces 22. The modem 24 and/or data receiver 25 can be coupled to an external network 38 enabling the computer system 12 to send and receive data signals, voice signals, video signals and the like via the external network 38 as is well known in the art. The external network 38 comprises, for example, the Internet, a wide area network WAN, a local area network LAN, a direct data link, or other similar network or communications link, including wireless networks. The modem 24 and/or the data receiver 25 can be coupled to receive data from a satellite transceiver 39, co-axial cable, fiber optic cable, etc. It is noted that the system 10 can be accessed and used by a remote user via the external network 38 and modem 24. The system 10 also comprises output devices coupled to the local interface 18 via the output interfaces 26, such as audio speakers 40, a printer 42, and the like.

The computer system 12 is programmed to display and execute a securities tracking software tool, according to the present invention, in graphical user interface GUI format. The computer system 12 also executes commands of the securities tracking software tool of the present invention as stored in the memory 16 or available remotely through the external network 38.

In one embodiment of the invention, in lieu of executing the software routines of the present invention on a local computer such as the computer system 12, a remote server receives pertinent data for analysis according to the teachings of the present invention, such as level one and level two data, and analyzes the data stream to produce statistics as described herein. The server outputs a data set, including the statistics, to a client computer or terminal over a network or communications link. The client can further process the received data and generate appropriate user displays.

According to one embodiment, the present invention receives data feeds from and utilizes the API (i.e., application programmers interface) with MB Trading Company of El Segundo, Calif. to gain access to level one data, level two data and time and sales data, and to conduct automated trading. As part of this API, several Active-X interfaces are made available to the user. These interface windows include watch lists, balances, alerts, level two information, open orders and positions. Those skilled in the art recognize that the present invention is capable of operating with securities information data feeds supplied by others, as the MB Trading Company feed is merely exemplary.

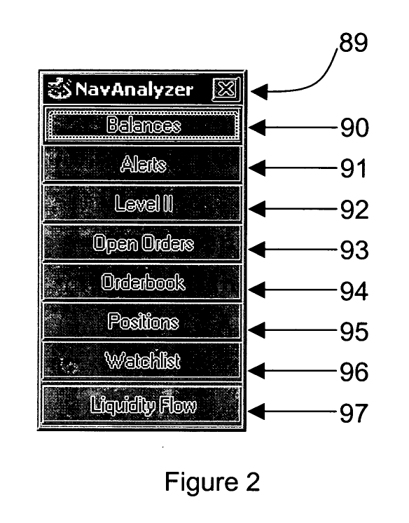

Referring to FIG. 2, a GUI diagram window 89, comprises, in one embodiment, eight mouse click buttons 90-97, wherein the button 97 launches a software module comprising features associated with the present invention. Each button is discussed in detail below.

The MB Trading “Balances” button 90 launches an Active-X window that provides user access to account balance and trading activity statistics such as buying power, account value, profit and loss.

The MB Trading “Alerts” button 91 launches an Active-X window that displays any trade errors that may have occurred, such as incorrectly submitting a trade order.

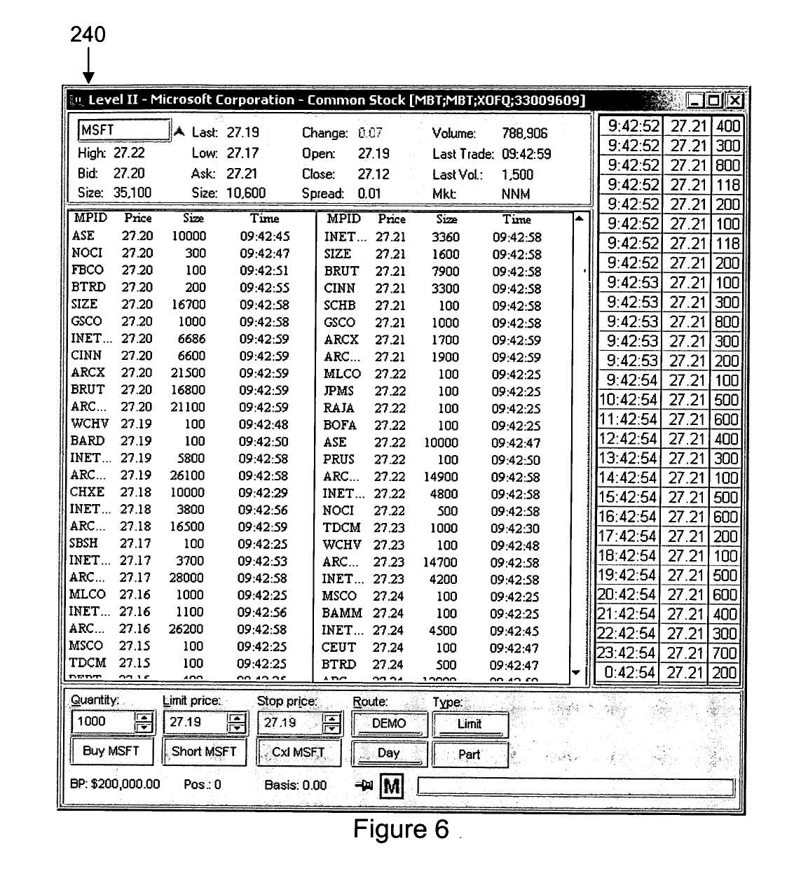

The MB Trading “Level II” button 92 launches an Active-X window that displays, in tabular form, the ticker symbol, market maker bid price, volume and time along one side of the table, and the market maker ask price, volume and time on the other side. The MB Trading Level II window is illustrated and further described in conjunction with FIG. 6. Other securities information such as high, low, bid, ask, change, size, spread, volume, last trade, and last volume are also included in the table display.

The MB Trading “Open Orders” button 93 launches an Active-X window that displays current live-order market status to the trader. All listed open orders are displayed along with the ticker symbol desired bid or ask price, the current bid price, current ask price, and time when the order was placed.

The MB Trading “Orderbook” button 94 launches an Active-X window that displays all trade orders that have been placed for the day. All placed and executed orders are listed along with the ticker symbol, entry price, buy or sell, short or cover, trade route, and time.

The MB Trading “Positions” button 95 launches an Active-X window that displays current market positions to the trader. All currently held positions are listed along with ticker symbol, quantity, last, change, basis, open, total, and stop price.

The MB Trading “Watch List” button 96 launches an Active-X window that displays for the user defined trading information, such as ticker symbol, last trade price, bid price, bid size, ask price, ask size, high, low, previous close and volume.

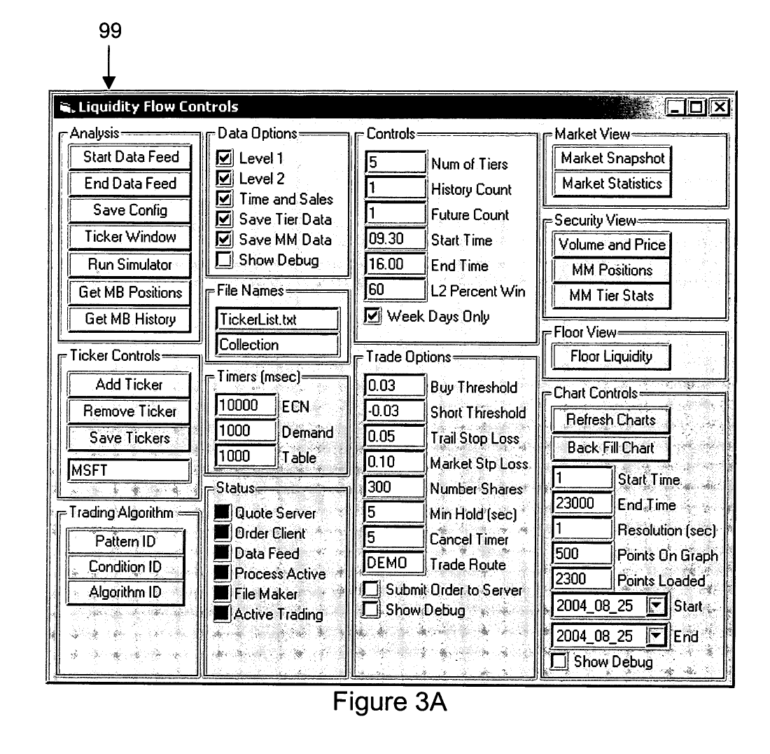

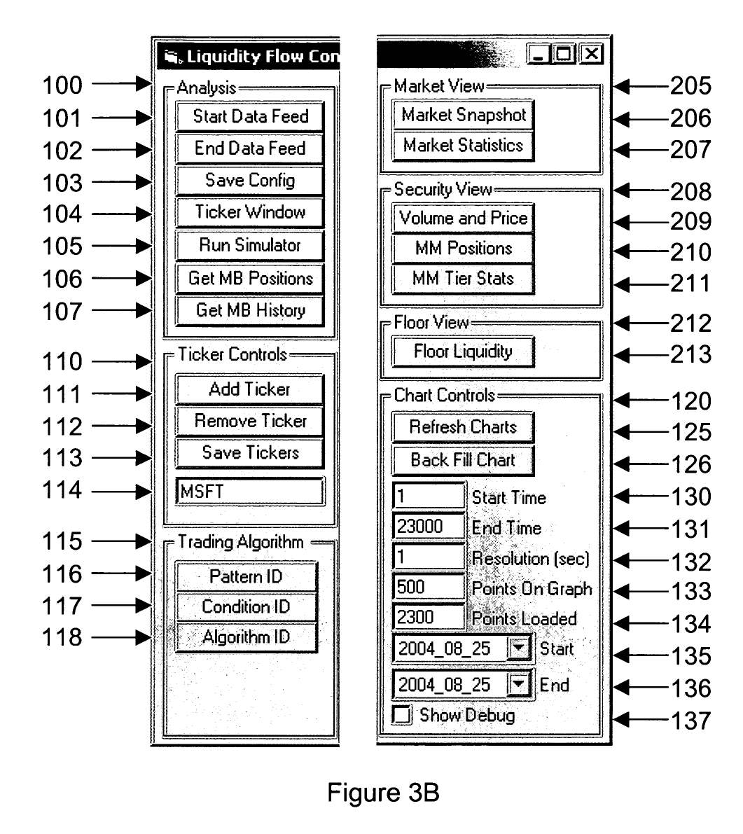

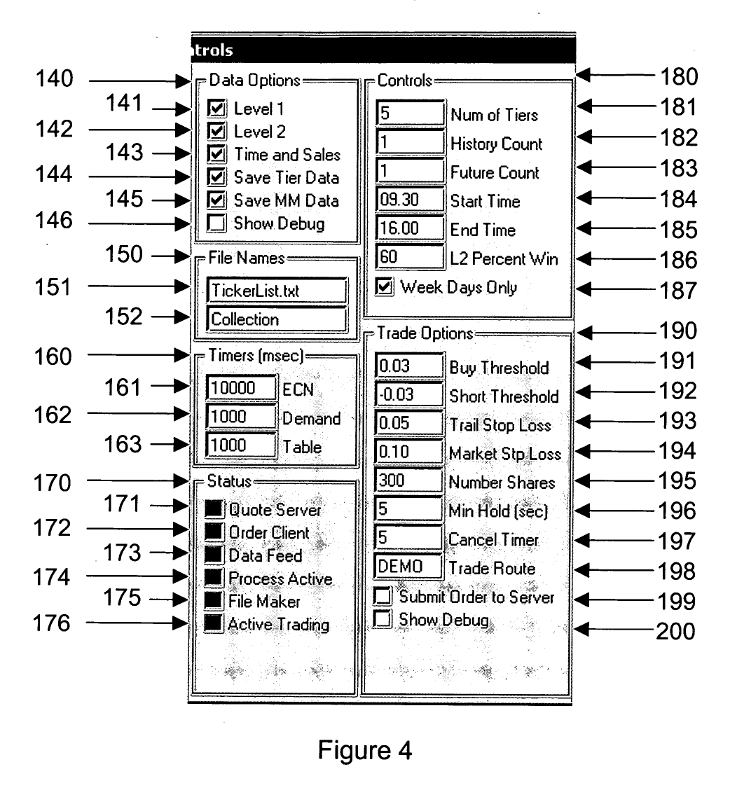

This invention presents a “Liquidity Flow” button 97 that launches a GUI liquidity flow controls interface 99 illustrated in FIGS. 3 and 4, comprising a plurality of user-controlled interface controls (i.e., input elements) that permit the user to filter and control the securities data supplied (for example by MB Trading Company), execute trades, control the contents and update frequency of the tier and market maker data files, control the simulated buy/sell options, control the automated buy/sell options and control the display or charting features. Generally, the GUI control interface 99 provides user control over execution of the liquidity flow program of the present invention. Using the GUI control interface 99, the user can, for example, load the chart windows (displays), backfill the charts with historical data, set automated trade options, perform trade simulations, begin and stop level one, level two, and time and sales data feeds, and set various timers and settings. With continuing reference to FIGS. 3 and 4, the GUI liquidity flow controls interface 99 contains user interface controls for the liquidity flow analysis, charting and trading, according to the teachings of the present invention. The liquidity flow controls are separated into several groups including: analysis 100, ticker controls 110, trading algorithm 115, data options 140, filenames 150, timers 160, status 170, controls 180, trade options 190, market view 205, security view 208, floor view 212, and chart controls 120. Each of these controls is described below.

Liquidity flow is defined generally as the bid and ask trade price and volume over time. A liquidity imbalance is present if there is an unusually high bid volume or ask volume. As further described below, the imbalance can be identified automatically according to user-defined trading algorithms or manually as the user reviews graphs and charts created according to the present invention.

The “Analysis” group 100 comprises, in one embodiment, seven mouse click buttons that initiate an action by the program. The mouse click buttons include: start data feed 101, end data feed 102, save configuration 103, ticker window 104, run simulator 105, get MB positions 106, and get MB history 107. Each of these mouse buttons is discussed below.

Upon clicking on the “Start Data Feed” button 101, the program sends a message to the data server enabling the level one, level two and time and sales streaming data feed for a ticker list of user-provided securities. The program dynamically creates the memory objects as necessary to process the streaming data feed.

Upon clicking on the “End Data Feed” button 102, the program sends a message to the data server disabling the level one, level two and time and sales streaming data feed for a user-defined list of securities or symbols. The program dynamically removes the memory objects as necessary.

Upon clicking on the “Save Configuration” button 103, the program saves the current variable settings to file. The file name for the configuration is defined in a textbox 151 of FIG. 4.

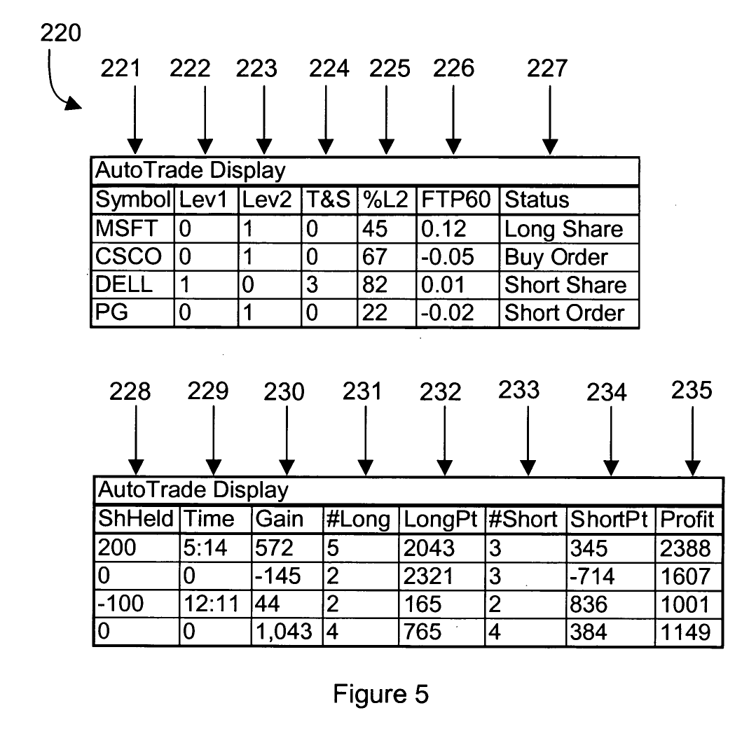

Upon clicking on the “Ticker Window” button 104, the program opens the auto trade display window 220 of FIG. 5.

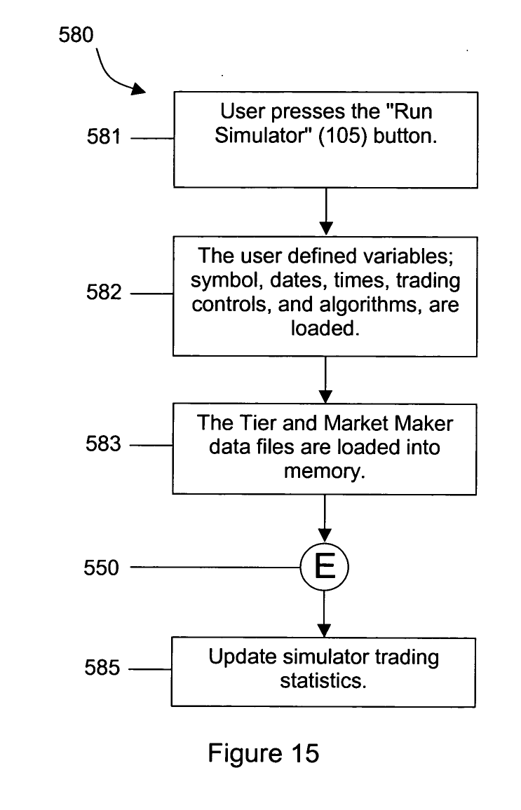

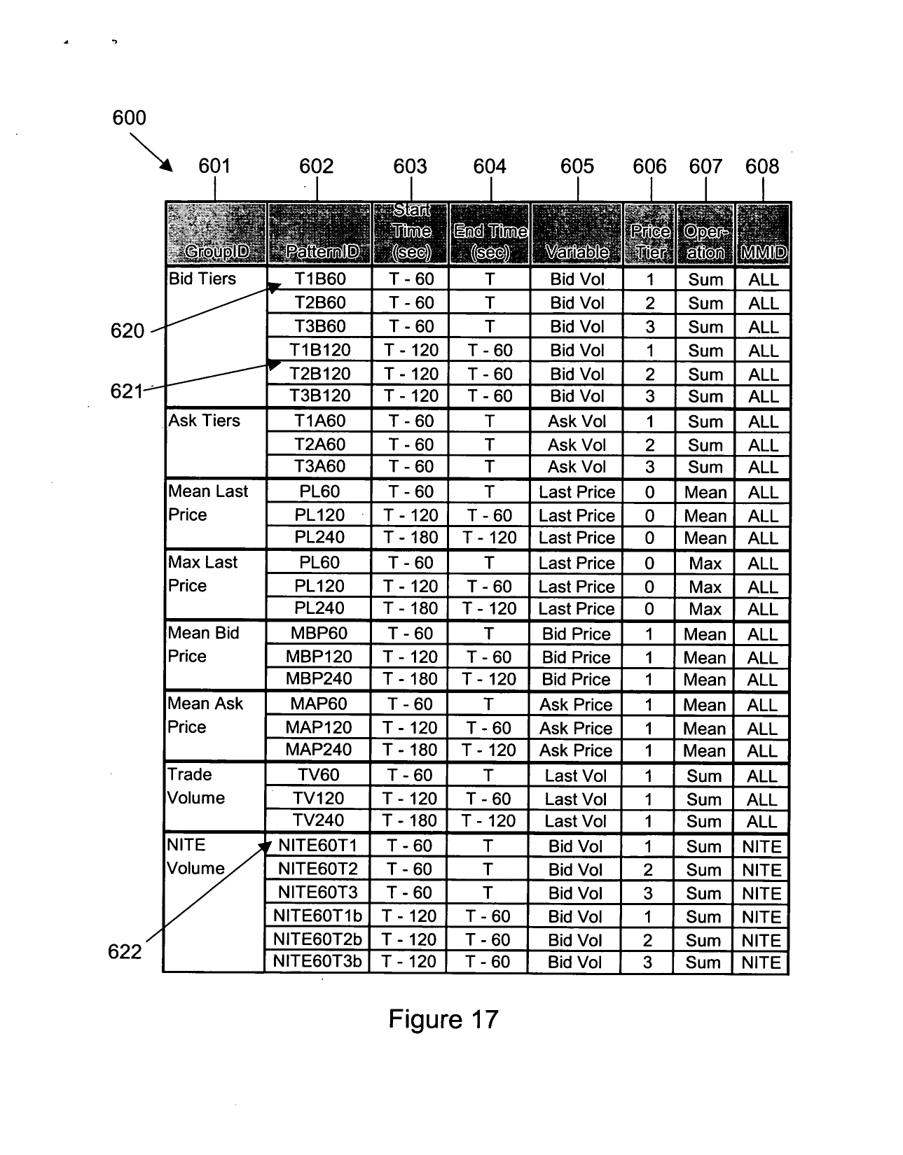

Upon clicking on the “Run Simulator” button 105, the program simulates trading based on threshold variables in the trade options 190 control group of FIG. 4, using historical securities data as recorded under user control by selecting the “Save Tier Data” checkbox 144 of FIG. 4. A flowchart for the simulated trading is illustrated in FIG. 15. As will be described further below, the user defines the simulation algorithms according to FIGS. 17-19. Clicking the “Run Simulator” button 105 causes the simulator to load the tier files and the market maker files into the memory 16. The simulator then checks the data for each timestamp entry to determine if a user-defined algorithm pattern is recognized. If a pattern is recognized, the simulator purchases the security based on the best ask price. The simulator holds the security until conditions indicate that it is time to sell (a trailing stop has been crossed, for example). The simulator sells the security based on the best ask price. The simulator tracks each trade and produces a final result of total trades and profit over the defined trading period.

Upon clicking on the “Get MB Positions” button 106, the program sends a message to the data server requesting an update of the currently held positions.

Upon clicking on the “Get MB History” button 107, the program sends a message to the data server requesting an update of the trade history for the day.

The “Ticker Controls” group 110, as part of the liquidity flow controls GUI 99, contains various ticker controls for the user. The controls include: an add ticker button 111, a remove ticker button 112, a save ticker button 113 and a ticker textbox 114.

Upon clicking on the “Add Ticker” button 111, the program adds the ticker that is listed in the ticker textbox 114 to the ticker list. If data is currently being collected, the program also enables the collection of level one, level two and time and sales messaging (data streaming) for the security represented by the newly added ticker. Also, in one embodiment, whenever any of the chart windows or display windows of the present invention are displayed, the user can right mouse click to call up an option to add a ticker.

Upon clicking on the “Remove Ticker” button 112, the program removes the ticker that is highlighted in an auto trade display window 220 (see FIG. 5) from the ticker list. If data is currently being collected for that ticker symbol, the program disables further data collection for the deleted ticker. In one embodiment, a right mouse click permits the user to remove a ticker during display of the charts and windows of the present invention.

Upon clicking on the “Save Tickers” button 113, the program saves the tickers listed in the auto trade display window 220 (see FIG. 5) to a file.

The “Trading Algorithm” group 115, as part of the liquidity flow controls GUI 99, comprises three buttons that launch the algorithm control tables. The button controls include: PatternID 116, ConditionID 117, and AlgorithmID 118.

Upon clicking on the “PatternID” button 116, the program launches the pattern definition table illustrated in FIG. 17 and described below.

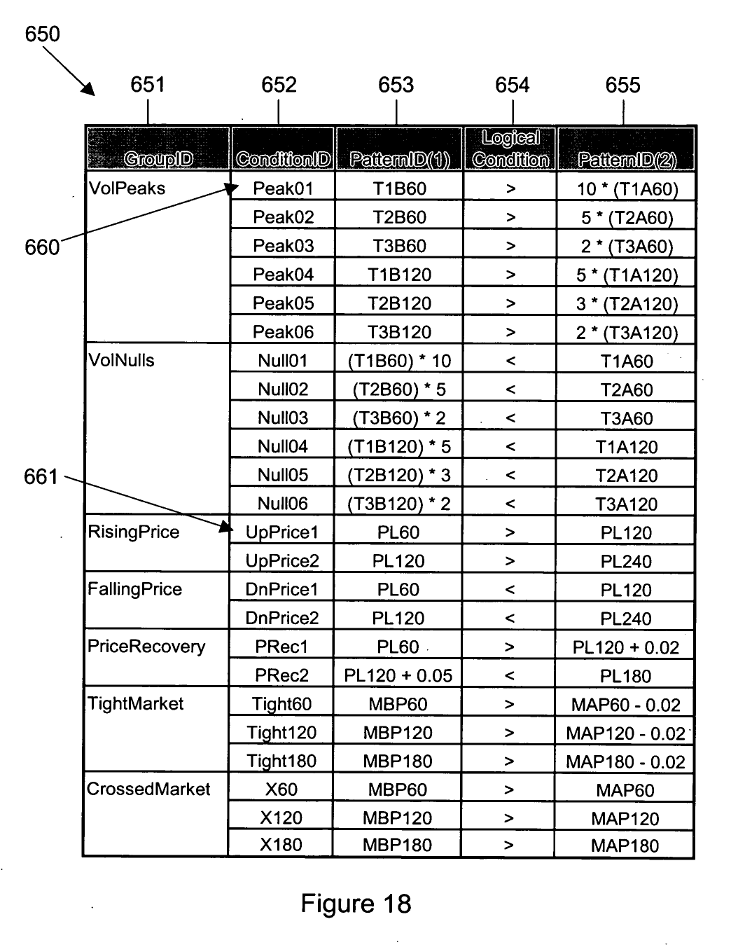

Upon clicking on the “ConditionID” button 117, the program launches the condition definition table illustrated in FIG. 18 and described below.

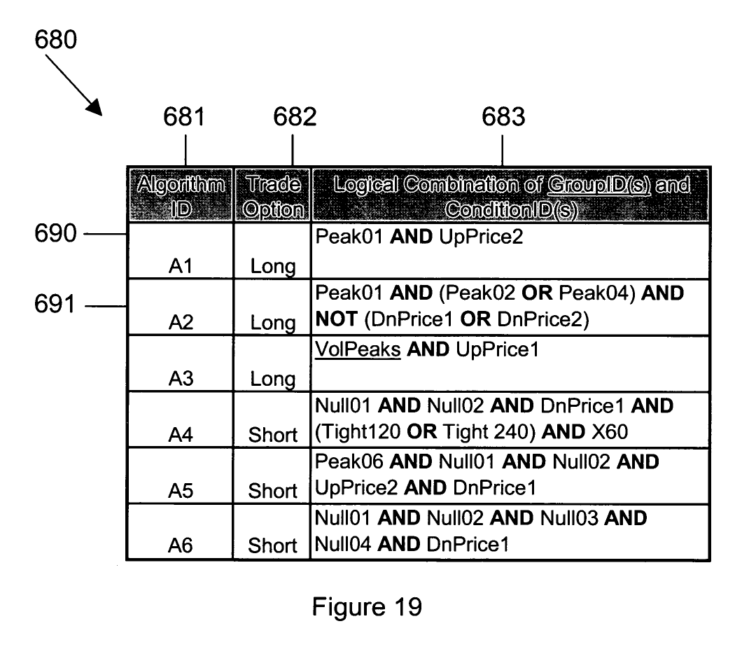

Upon clicking on the “AlgorithmID” button 118, the program launches the algorithm definition table illustrated in FIG. 19 and described below.

The “Market View” group 205, as part of the liquidity flow controls GUI 99, contains two buttons that launch the market view charts. The charting buttons include: market snapshot 206, and market statistics 207.

Upon clicking on the “Market Snapshot” button 206, the program launches a new chart window containing a snapshot of current market liquidity, as illustrated in FIG. 8.

Upon clicking on the “Market Statistics” button 207, the program launches a new chart window containing summary statistics of current market liquidity, as illustrated in FIG. 8. The statistics can be presented in text or graph form, such as the FIG. 8 bar graph.

The ‘Security View group 208, as part of the liquidity flow controls GUI 99, contains three buttons that launch the security view charts. The charting buttons include: volume and price 209, market maker positions 210 and market maker tier stats 211.

Upon clicking on the “Volume and Price” button 209, the program launches a new chart window containing the liquidity flow with price reaction information, as illustrated in FIG. 9.

Upon clicking on the “MM Positions” button 210, the program launches a new chart window containing a real-time snapshot of market maker price tier and volume information, as illustrated in FIG. 10.

Upon clicking on the “MM Tier Stats” button 211, the program launches a new chart window containing the real-time market maker statistical tiers, as illustrated in FIG. 11.

The “Floor View” group 212, as part of the liquidity flow controls GUI 99, contains one button that launches the market floor chart. The button is labeled “Floor Liquidity” 213.

Upon clicking on the “Floor Liquidity” button 213, the program launches a new chart window containing the real-time detailed market maker volume across time, as illustrated in FIG. 12.

The “Chart Controls” group 120, as part of the liquidity flow controls GUI 99, contains various charting controls for the user. The button controls include: refresh charts 125, and backfill chart 126. The textbox controls include start time 130, end time 131, resolution 132, points on graph or display time (typically in minutes) 133, points loaded 134, start date 135, end date 136 and show debug 137.

Upon clicking on the “Refresh Charts” button 125, the program sends a command to the open charts to refresh the graphics or update plot variables.

Upon clicking on the “Backfill Chart” button 126, the program loads the data defined by start date 135, end date 136, start time 130 and end time 131 into memory. The data is then loaded into a chart display.

By changing the “Start Time” textbox 130 the user sets the starting time in memory or a specific time in the day, that the charts display.

By changing the “End Time” textbox 131 the user sets the final time in memory or a specific time in the day that the charts display.

By changing the “Resolution” textbox 132 the user sets a resolution filter for the display of data. A value of one includes every data point collected on the time charts. A resolution of two includes every other data point collected on the time charts. A resolution of three includes every third data point, and so on.

By changing the “Points On Graph” textbox 133 the user sets the number of x-axis points that are graphed in the liquidity flow price reaction chart as shown in FIG. 9.

By changing the “Points Loaded” textbox 134 the user sets the number of points loaded into memory for the liquidity flow price reaction chart of FIG. 9. The “points loaded” is the total number of points loaded into memory for a graph. If loading a historical graph, the program will load the 2300 points (as set forth in the exemplary textbox 134 of FIG. 3) into memory for graphing. A horizontal scroll bar is used to move the graph beyond the number of points displayed on the graph (as set for the in the exemplary textbox 133 of FIG. 3). If using a real-time graph, the program loads the historical data needed to fill the graph with the 2300 points. While the streaming feed is continuous, the graph updates occur on a user-defined time interval (typically, once every second).

By clicking on the “Start” date pull down textbox 135 the user sets the starting date for chart data and simulator analysis.

By clicking on the “End” date pull down textbox 136 the user sets the ending date for chart data and simulator analysis.

By clicking on the “Show Debug” checkbox 137 the user enables the viewing of several debug messages to the screen. The “Data Options” group 140, see FIG. 4, as part of the liquidity flow controls GUI 99 comprises messaging controls including: level one 141, level two 142, time and sales 143, save tier data 144, save market maker data 145 and show debug 146.

By selecting the “Level One” checkbox 141, the program sends a message to the data server enabling the level one messaging for all symbols in the ticker list. By unselecting the “level One” checkbox 141, the program sends a message to the data server disabling the level one messaging for all symbols listed in the auto display window 220 of FIG. 5.

By selecting the “Level Two” checkbox 142, the program sends a message to the data server enabling the level two messaging for all symbols in the ticker list. By unselecting the “Level Two” checkbox 142, the program sends a message to the data server disabling the level two messaging for all symbols listed in the auto trade display window 220.

By selecting the “Times and Sales” checkbox 143, the program sends a message to the data server enabling the times and sales messaging for all symbols in the ticker list. Times and sales is a messaging format that is the actual ticker tape of trade activity. By unselecting the “times and sales” checkbox 143, the program sends a message to the data server disabling the times and sales messaging for all symbols in the ticker list.

By selecting the “Save Tier Data” checkbox 144, the program creates tier data files for all symbols in the ticker list. Each tier data file includes the following information, typically updated once every second: timestamp hour, minute, second, last price, tick, total volume, quote bid price, quote ask price, bidvoltier1, askvoltier1, bidvoltier2, askvoltier2, etc. The number of tiers is a user-defined parameter 181. A single tier, for example, provides the user with the best bid price, best ask price and their associated volumes. Although this is important information, it is limited in scope. For example, there may be a major seller of the security located at five cents above the best ask price. By requesting more than a single data tier, the user can see the large selling pressure that is five cents from the best ask price. This historical tier data file is later used to backfill various charts and perform simulated trading as described below.

By selecting the “Save MM Data” checkbox 145, the program creates the market maker “MM” data files for all symbols in the ticker list. The market maker data file includes the following information, typically updated once every second: timestamp hour, minute, second, market maker ID, market maker bid price, market maker ask price, market maker bid volume, market maker ask volume for each market maker within a user-defined number of price tiers. This historical market maker file is later used to backfill various charts and perform simulated trading.

By clicking on the “Show Debug” checkbox 146 the user enables the viewing of several debug messages to screen.

The “File Names” group 150, as part of the liquidity flow controls GUI 99, comprises the file name and location for the ticker list 151 and collection files 152.

The “TickerList.txt” textbox 151 defines the file name for the ticker list.

The “Collection” textbox 152 defines the directory where the tier files and market maker files are located.

The “Timers” msec 160 as part of the liquidity flow controls GUI 99, contains the various data collection and update timers. These include memory cleanup 161, demand calculations 162 and table updates 163.

The value in the “ECN” (Electronic Communications Network) textbox 161, as part of the liquidity flow controls GUI 99, controls how often (in milliseconds) the program goes through the market maker memory objects, in one embodiment, once every ten seconds. The memory objects are removed if they are not active. ECNs are public trade platforms where day traders, stockbrokers, and even market makers place orders to buy and sell securities. The program of the present invention stores a memory object for every bid and ask trade price and volume, for each market maker and each ECN. As the trade price changes, more objects are created. The program eliminates the memory objects if their price is not within the current trade price, plus or minus the two times (in the preferred embodiment) the number of tiers as set forth in a number of tiers box 181.

The value in the “Demand” textbox 162, as part of the liquidity flow controls GUI 99, controls the frequency (or time interval) for calculating the volume per price tier from each market maker object, updates the memory objects for each graph and refreshes the view for each graph. The exemplary value of 1000 msec indicates that the algorithm calculations, such as check market maker memory objects and update the tier memory objects, write to file, perform automated trading, etc., are updated every second.

The value in the “Table” textbox 163, as part of the liquidity flow controls GUI 99, controls the update frequency (or time interval) of the auto trade display window 220. A value of 1000 msec indicates that the display window is updated every second.

The “Status” group 170, as part of the liquidity flow controls GUI 99, contains various data collection, data processing and active trading indicators. These indicators include: quote server 171, order server 172, data feed 173, process active 174, file maker 175 and active trading 176.

The light indicator “Quote Server” 171, as part of the liquidity flow controls GUI 99, shows the user the current connection status to the data quote server. If the color is green, the program is currently connected to the data quote server. If the color is red, the program is not connected to the quote server. The quote server is used to receive the level one, level two and time and sales data messages. Without a connection to the quote server, the charts and simulator utilize only historical data.

The light indicator “Order Server” 172, as part of the liquidity flow controls GUI 99, shows the user the current connection status to the order server. If the color is green, the program is currently connected to the order server. If the color is red, the program is not connected to the order server. The order server is used to execute trade commands and to access account information.

The light indicator “Data Feed” 173, as part of the liquidity flow controls GUI 99, shows the user the current data feed status. If the color is green, the program is receiving live level one, level two and time and sales data from the quote server. If the color is red, the program is not receiving live level one, level two, and time and sales data from the quote server.

The light indicator “Process Active” 174, as part of the liquidity flow controls GUI 99, shows the user the current program analysis status. If the color is green, the program is processing data for a simulation. If the color is red, the program is not processing data for a simulation.

The light indicator “File Maker” 175, as part of the liquidity flow controls GUI 99, shows the user the current program file making status. If the color is green, the program is writing to a file. If the color is red, the program is not writing data to file. The file types include configuration settings, ticker list, tier data files, and market maker data files.

The light indicator “Active Trading” 176, as part of the liquidity flow controls GUI 99, shows the user the current program trading status. If the color is flashing green, the program is in automatic trade mode. Thus in this mode if a data value falls below or rises above a predetermined trading threshold, the program trades of the present invention is automatically requested. If the color is red, the program is in manual trade mode, i.e., the user must manually initiate a trade.

The “Controls” group 180 as part of the liquidity flow controls GUI 99, contains various data collection and analysis control settings. The following textboxes are part of the controls group: number of tiers 181, history count 182, future count 183, start time 184, end time 185, level two percent window 186 and the checkbox week days only 187.

The “Num of Tiers” 181 textbox, as part of the liquidity flow controls GUI 99, tells the program the number of tiers that should be considered while performing data collection, simulations and charting. For example, assume a given security is trading at $48.80, while the best bid price is at $48.79. An order is then placed for 10 million shares at $48.75, which is considered a large order. The $48.75 price is four tiers away from the best bid price of $48.79. Thus if the “Num of Tiers” 181 textbox contains a four, the $48.75 price is considered in performing the various program operations. If the “Num of Tiers” 181 textbox contains a three, the $48.75 order is not considered by the program. Note that the 10 million shares order sets a trading minimum and indicates the price will be going up in the near future. Thus it would be preferable to include that order in the program processing.

The “History Count” textbox 182, as part of the liquidity flow controls GUI 99, tells the program the number of historical data samples that the simulator should use in calculations.

The “Future Count” textbox 183, as part of the liquidity flow controls GUI 99, tells the program the number of future data samples that the simulator should use in calculations to determine expected future trade price delta.

The “Start Time” textbox 184, as part of the liquidity flow controls GUI 99, tells the program the time to start collecting data and perform trading. If the Automatic trading option is selected trading begins at the Start Time.

The “End Time” textbox 185, as part of the liquidity flow controls GUI 99, tells the program the time to stop collecting data and end trading.

The “L2 Percent Win” textbox 186, as part of the liquidity flow controls GUI 99, tells the program the amount of time in seconds the trades are tracked to correspond to a securities exchange that provides level two data. As is known, stock trades are occurring on many different exchanges simultaneously for a single stock. Level two data (bid and ask prices and volume) is only available from certain exchanges and ECNs. For example, level two data is not currently available from the NYSE. Level one data is based on all trading activity (not just the bid and ask activity). The user will see the level one data from every exchange and ECN. Therefore, the “L2 Percent Win” is the percentage of trades that occur on exchanges (or ECNs) where the level two data is provided.

The “Week Days Only” checkbox 187, as part of the liquidity flow controls GUI 99, tells the program to only allow a data feed during weekdays Monday-Friday.

The “Trade Options” group 190 as part of the liquidity flow controls GUI 99, contains various options for the automatic trading and simulator algorithms. The control variables include buy 191 and short 192 thresholds, trailing stop loss value 193, market loss value 194, trade shares 195, nimum trade hold time 196, trade cancel timer 197, trade route 198, submit order checkbox 199 and show debug 200 option.

The “Buy Threshold” textbox 191, as part of the liquidity flow controls GUI 99, tells the program the necessary future trade price value to initiate a buy order either in a simulation or automated trading.

The “Short Threshold” textbox 192, as part of the liquidity flow controls GUI 99, tells the program the necessary future trade price value to initiate a short order either in a simulation or automated trading.

The “Trail Stop Loss” textbox 193, as part of the liquidity flow controls GUI 99, tells the program the trailing stop loss value necessary to exit a position either during simulation or automated trading.

The “Market Stop Loss” textbox 194, as part of the liquidity flow controls GUI 99, tells the program the market stop loss value necessary to exit a position either during simulation or automated trading.

The “Number Shares” textbox 195, as part of the liquidity flow controls GUI 99, tells the program the number of shares to be traded either during simulation or automated trading.

The “Min Hold Time sec” textbox 196, as part of the liquidity flow controls GUI 99, tells the program the minimum hold time for automated trading. Setting an adequate minimum threshold prevents prematurely exiting of a security position.

The “Cancel Timer sec” textbox 197, as part of the liquidity flow controls GUI 99, tells the program the maximum time to allow a live order to remain on the market floor without being completely filled. The cancel timer begins when the order is first placed. If the order is filled, the cancel timer is deleted. If the order is not completely filled, and the order has been live for more seconds than the cancel timer allows; the program automatically cancels the current live orders for this security.

The “Trade Route sec” textbox 198, as part of the liquidity flow controls GUI 99, tells the order server 172 which route, e.g., Market Maker or ECN to use to place the current order.

The “Submit Order to Server” textbox 199, as part of the liquidity flow controls GUI 99, tells the program to run the algorithm and submit actual orders to the order server 172. The submit order to server checkbox needs to be selected for automated trading to be enabled.

Referring to FIG. 5, a table window 220 contains trade status and message update information for a security. The information included in the auto trade display window includes: symbol 221, level one 222, level two 223, time and sales 224, percent level two 225, FTP60 226, status 227, shares held 228, time 229, gain 230, number long 231, long profit 232, number short 233, short profit 234 and profit 235.

The “Symbol” table header 221, as part of the auto trade display window 220, tells the user the current ticker symbol for table updates.

The level one, “Lev1,” table header 222, as part of the auto trade display window 220, tells the user the time, in seconds, that has elapsed since the last level one message has been received for this security.

The level two, “Lev2,” table header 223, as part of the auto trade display window 220, tells the user the time, in seconds, that has elapsed since the last level two message has been received for this security.

The “Time and Sales” table header 224, as part of the auto trade display window 220, tells the user the time, in seconds, that has elapsed since the last time and sales message has been received for this security.

The “Level Two Percent” table header 225, as part of the auto trade display window 220, tells the user the percent of trades that have occurred on an exchange that has level two data posted on the trading floor.

The “Future Trade Price” table header 226, as part of the auto trade display window 220, tells the user the predicted trade price delta for this security. As described further below, when a user runs the trade simulator, the user-defined algorithms execute using the historical security data. The trading statistics are presented and a look-up table is created. The table includes each pattern with historical price performance results.

The “Status” table header 227, as part of the auto trade display window 220, tells the user a current status of the automatic trading for this security.

The “Shares Held” table header 228, as part of the auto trade display window 220, tells the user the status of the number of shares currently held in this security for the automatic trading.

The “Time” table header 229, as part of the auto trade display window 220, tells the user how long the current long or short position has been held. Once the position is closed, the timer is reset to zero.

The “Gain” table header 230, as part of the auto trade display window 220, tells the user the trading grain for this security's previous trade during automated trading.

The “Number Long” table header 231, as part of the auto trade display window 220, tells the user the number of long trades for this security that have been placed during the current automated trading session.

The “Long Profit” table header 232, as part of the auto trade display window 220, tells the user average long profit for this security from the current automated trading session.

The “Number Short” table header 233, as part of the auto trade display window 220, tells the user the number of short trades for this security that have been placed during the current automated trading session.

The “Short Profit” table header 234, as part of the auto trade display window 220, tells the user the average short profit for this security from the current automated trading session.

The “Profit” table header 235, as part of the auto trade display window 220, tells the user the average profit for this security from the current automated trading session

Referring to FIG. 6, a table window 240, that is part of the MB Trading Active-X module, contains the market maker bid and ask status. The table status information includes market maker identification code, bid price, bid size, time of last bid, ask price, ask size, and time of last ask update. Other trading information includes a running list of each trade time, price and volume size. MB trading also includes dynamic trade controls through this display window.

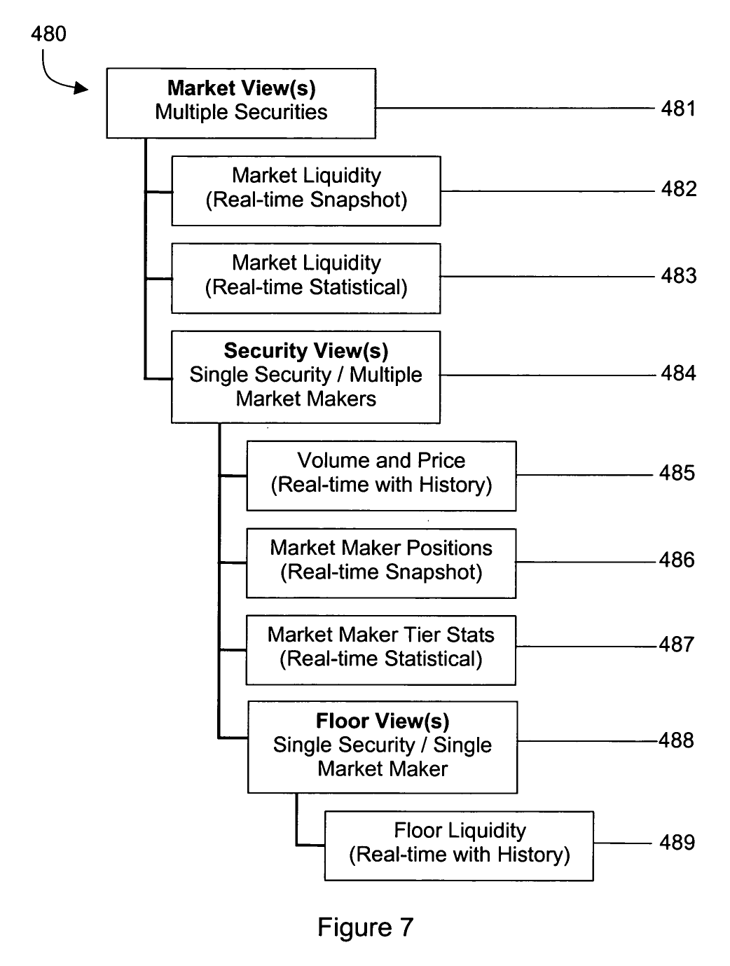

FIG. 7 is a diagram illustrating the chart display hierarchy of views according to the present invention. The charting hierarchy breaks the market data into three separate views: market view 481, security view 484 and floor view 488.

The market view 481 shows the liquidity information for multiple securities. The charts are updated with real-time data on a user defined frequency, typically once every second, as determined by the user-entry into the textbox 162 of FIG. 4. The market view chart comprises either a real-time snapshot of the current liquidity tiers 482 or a real-time moving average of the current liquidity tiers 483. The real-time snapshot view 482 includes a chart with the current bid volume and ask volume liquidity tiers cumulative for each security. The statistical summary view 483 is a chart with the moving average of the cumulative bid volume and ask volume tiers across a user defined timeframe, typically 60 minutes, as determined by the user-entry into the textbox 133 of FIG. 3.

The security view 484 shows the liquidity for a single security. In one embodiment, the security view chart comprises three types of charts. All three charts are updated with real-time data on a user defined frequency, typically once every second. The first chart, volume and price 485, shows the real-time security liquidity with history. The history window is a user-defined timeframe, typically 60 minutes. The second chart, market maker positions 486, shows the real-time snapshot of liquidity per market maker. The third chart, market maker tier bias 487, displays the moving average of the bid volume and ask volume for each market maker tier across a user defined timeframe, typically 60 minutes, as determined by the user entered value in the text box 133 of FIG. 3.

The floor view 488 shows the liquidity for a single market maker or ECN. The floor view charting level includes one chart. The floor view chart is updated with real-time data on a user defined frequency, typically once every second. The floor liquidity chart 489 shows the real-time bid volume and ask volume per price tier with history for a specific market maker or ECN. The history window is a user-defined timeframe, typically 60 minutes.

By right clicking with the mouse on any FIG. 7 chart displayed on the display 28 of FIG. 1, a window opens to provide the user with the option to launch or switch to any of the other charts. Additionally, the user can drill down to more detailed views within any chart. For example, a right mouse click on the market view chart (481/482/483), allows the user to see more details for that specific security. The user could further drill down from the security view to the floor view.

Referring to FIG. 8, a chart window 300 and a table window 307, illustrate one method for viewing the market liquidity for several securities simultaneously. That is, FIG. 8 illustrates the market view 481 of FIG. 7, either the real-time snapshot of the current liquidity tiers 482 or a real-time moving average of the current liquidity tiers 483. The chart window 300 displays the bid volume 302 (comprising a bid volume element 303 for each security) as vertical bars on the positive y-axis and the ask volume 304 (comprising an ask volume element 305 for each security) as vertical bars on the negative y-axis. A length of each region of each bar represents the volume at each bid/ask tier. Each security is identified with a security ticker label 306 representing the ticker symbol. The chart can display multiple timeframes, typically one hour, two hours or three hours simultaneously to help identify liquidity trends and bias. According to various embodiments of the invention, the chart can simultaneously display bid and ask volumes for a first timeframe (the last hour, for example) and bid and ask volumes for a second timeframe (the last two hours, for example), allowing the user to identify volume changes. Also, the volume data can be a real-time snapshot, an average (calculated over a predetermined time window) or a moving average (with a predetermined averaging time window and a time increment for updating the moving average) or a combination of the preceding. In the table window 301 a display of the raw data values for the bid and ask chart is optionally displayed. The chart can be viewed with various display methodology such as line, area, bar, point, etc., at the users selection. Generally, the chart controls 120 of FIG. 3 control the display aspects of the various charts of the present invention.

Referring to FIG. 9, a chart window 319 comprises four chart areas for a single security. The chart areas include trade price block area 320 with a price vertical axis, bid volume per price tier block area 330 and ask volume per price tier block area 337 with a demand vertical axis, and trade volume block area 340 with a volume vertical axis. The chart areas are synchronized along the same x-axis, which is based on a user-defined length of time. The chart can be viewed with various display formats such as line, area, bar, point, etc.

The trade price 320 chart area contains three plotted variables, best ask price 321, best trade price 322 and best bid price 323. Data processing methods that help in viewing the data are available; such as moving average, candlestick charts, etc.

The bid volume 330 chart area contains the cumulative bid volume for all market makers and ECNs at each bid price. Tier 01 bid price is the best bid price. Tier 01 bid volume is the cumulative bid volume at the tier 01 bid price. Tier 02 bid price is the best bid price—$0.01. Tier 02 bid volume is the cumulative bid volume at the tier 02 bid price. Tier 03 bid price is the best bid price—$0.02. Tier 03 bid volume is the cumulative bid volume at the tier 03 bid price. The number of displayed tiers is a user defined variable 181 of FIG. 4.

The ask volume 337 chart area contains the cumulative ask volume for all market makers and ECNs at each ask price. Tier 01 ask price is the best ask price. Tier 01 ask volume is the cumulative ask volume at the Tier 01 ask price. Tier 02 ask price is the best ask price+$0.01. Tier 02 ask volume is the cumulative ask volume at the tier 02 ask price. Tier03 ask price is the best ask price+$0.02. Tier 03 ask volume is the cumulative ask volume at the tier 03 bid price. The number of tiers is a user defined variable 181 of FIG. 4.

The trade volume 340 chart area contains a cumulative trade volume. As new time and sales messages are received, the program takes the trade volume and adds it to a cumulative counter. As the demand timer 162 see FIG. 4 runs, the program takes the cumulative trade volume, sends that value to the chart, refreshes the chart, and resets the sum to zero. Typically, the demand timer 162 is set to a one-second resolution.

FIG. 10 illustrates a chart window 350 and a table window 360. Price is plotted along the x-axis. The average of the best bid price and the best ask price is at a center 349 of the x-axis, the actual bid and ask prices are shown on the x-axis at the bottom of the chart window 350. The chart can be rendered with various display formats such as line, area, bar, point, etc.

The bid volume 351 is charted as a positive stacked bar graph, with each stack element representing a different market maker or ECN as listed below each bar for the bid volume information and above each bar for the ask volume information. A height of each stack element represents the bid/ask volume corresponding to the market maker. Tier 01 bid price is the best bid price. Tier 01 bid volume is the bid volume for each market maker at the tier01 bid price. Tier 02 bid price is the best bid price −$0.01. Tier 02 bid volume is the bid volume for each market maker at the tier 02 bid price. Tier 03 bid price is the best bid price −$0.02. Tier 03 bid volume is the bid volume for each market maker at the tier 03 bid price. The number of tiers is a user defined variable 181 in FIG. 4. Each market maker identification label is listed corresponding to the volume 353.

The ask volume 354 is charted as a negative stacked bar graph, with each stack element representing a different market maker or ECN. The ask volume is charted as negative to isolate the display from the bid volume. Tier 01 ask price is the best ask price. Tier 01 ask volume is the ask volume for each market maker at the tier 01 ask price. Tier 02 ask price is the best ask price +$0.01. Tier 02 ask volume is the ask volume for each market maker at the tier 02 ask price. Tier 03 ask price is the best ask price +$0.02. Tier 03 ask volume is the ask volume for each market maker at the tier 03 ask price. The number of tiers is a user defined variable 181 of FIG. 4. Each market maker identification label is listed corresponding to the volume 352.

The bid volume and ask volume table 360 comprises data values that correspond to the volume charts above. Bid values are listed as positive 361 and ask values are listed as negative 362 to highlight their differences.

FIG. 11 illustrates a chart window 369 and a table window 380 for a single security. The chart window 369 displays each market maker's total bid volume 371 per price tier (each region of the bar representing a different price tier) as a positive value. To help isolate the two variables, the total ask volume 373 per price tier is displayed as a negative value (with each region of the bar representing a different price tier). Tier 01 bid price is the best bid price at that time and tier 01 ask price is the best ask price at that time. The volume across the past hour, for example, is summed for each price tier. The chart can display multiple timeframes typically, 1 hour, 2 hour, 3 hour simultaneously to identify market maker trends and biases. The volume data can be a real-time snapshot, a moving average, or a combination of the two. The chart 369 comprise labels 372 that identify the market maker or ECN. The data values that correspond to the bid volume and ask volume chart are displayed in the optional table 380. The chart can be viewed with various display methodologies such as line, area, bar, point, etc.

FIG. 12 illustrates a chart window 389 and a table window 396. The chart window 389 displays the trade interest for a specific market maker (or ECN) across time. The chart is comprised of three sections, bid volume 390, ask volume 393 and the data table 396. The chart can be viewed with various display methodologies such as line, area, bar, point, etc.

The bid volume section 390 includes four bid price tiers 392 along the positive y-axis and the bid volume magnitude indicated as vertical bars 391 for each price tier. A lower edge of each vertical bar 391 is within one of the bid price tiers and thereby indicates the bid price tier associated with the vertical bar 391. Time increments are indicated along the x-axis.

The ask volume section 393 includes ask price tiers 395 along the negative y-axis and the ask volume magnitude indicated as vertical bars 394 for each ask price tier. An upper edge of each vertical bar 394 is within one of the ask price tiers and thereby indicates the ask price tier associated with the vertical bar 304.

Data values corresponding to the bid volume/price and ask volume/price data presented in the chart window 389 are displayed in the optional table 396.

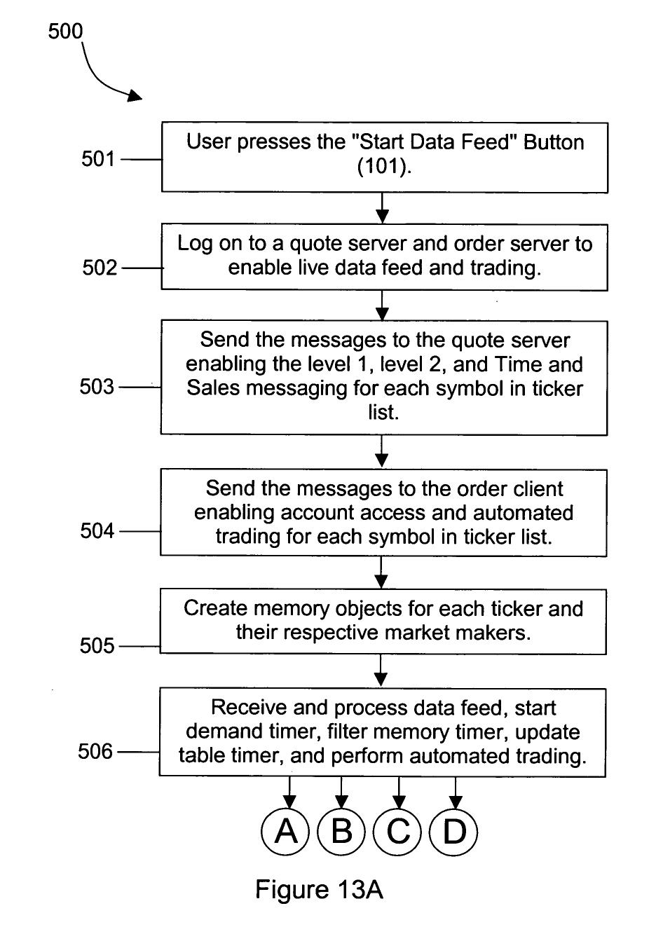

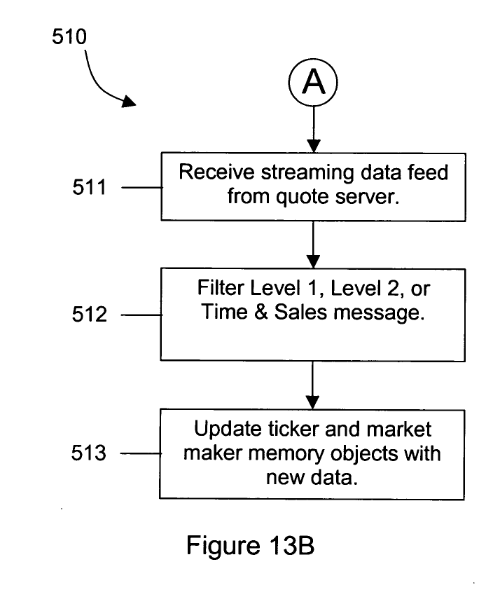

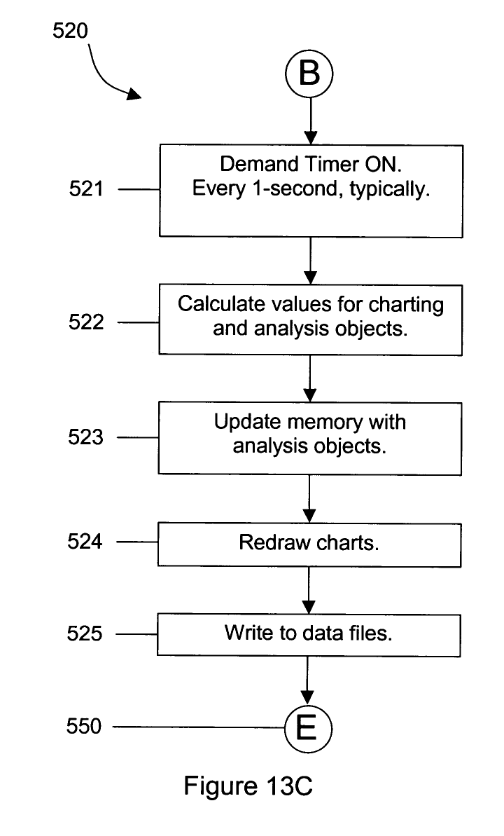

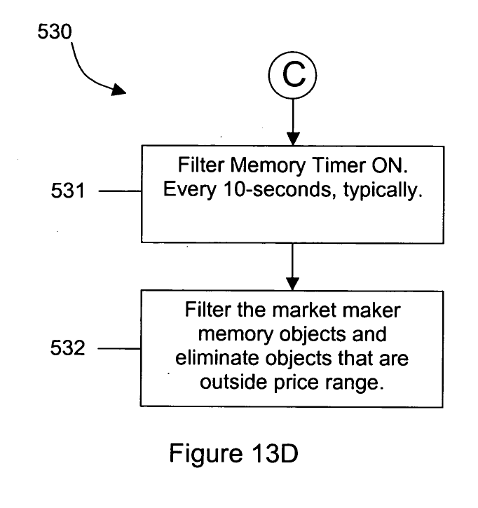

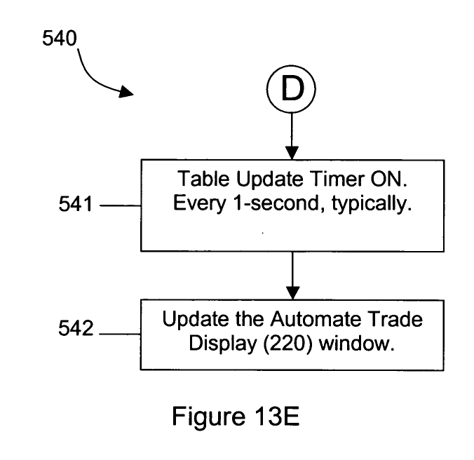

FIG. 13A depicts a flowchart 500 of the program data feed and process timers. The data feed begins at a step 501 when the user presses the “Start Data Feed” button 101 in FIG. 3. A message is sent to the data server to enable level one, level two and time and sales messages (assuming the user has selected those data types in the FIG. 3 check boxes 141-143) and several timers are started. Each timer is indicated on a different flowchart branch with a short description of functions called within that timer. The first timer, demand 520, is updated in one embodiment every 1-second interval. Within the demand 520 flowchart branch, liquidity variables are calculated 522, charts are redrawn 524, data files are written 525 and automated trading 550 is performed. A filter memory timer 530 cycles through the market maker memory objects and eliminates any objects that are no longer active. A table update timer 540 updates each column in the automated trade display 220 window of FIG. 5. The chart can be viewed with various display methodologies such as line, area, bar, point, etc.

Returning to the “Start Data Feed” button 501, when the user presses the “Start Data Feed” Button 501, which is an element in the data feed flowchart 500, the data feed begins. The user is required to log on to the quote and order servers 502. The program connects to the quote server and sends messages enabling level one, level two and time and sales streaming data feed 503 for all tickers in the ticker list. The program then connects to the order server and sends messages enabling account access and automated trading 504. Memory objects are initialized 505 and prepared to receive and process the streaming data feed 510. Finally, the calculation and refresh timers are started 506.

The streaming data feed branch 510 of the flowchart 500 shows the data is first received from a quote server 511. The message data is filtered to a level one, level two or times and sales message 512. The memory objects are then updated 513 with the relative message information.

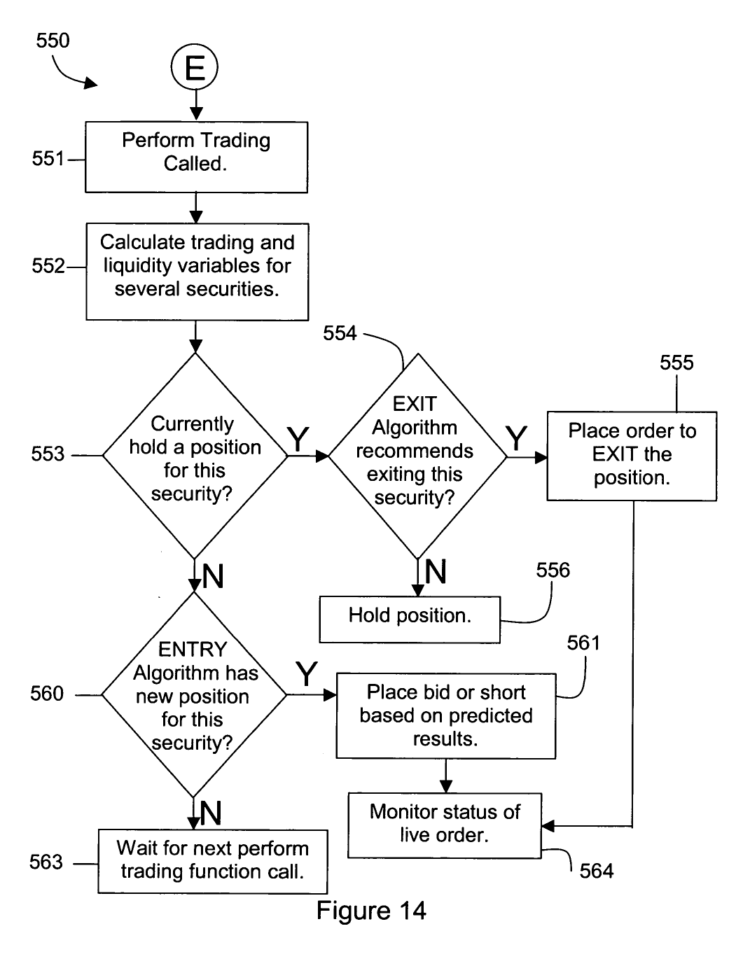

The demand timer branch 520 of the flowchart 500 shows the various function calls that occur in the demand timer. In one embodiment the timer is set to update once every second 521. The demand timer calls several functions that calculate variables 522 and load memory arrays 523 necessary for charting and automated trading. The chart views are then refreshed with the new object variables 524. Next, the demand timer updates the tier and market maker data files. The final function that the demand timer calls is the perform trading algorithm, which is displayed as a flowchart branch 550 in FIG. 14.

The filter memory timer branch 530 of the flowchart 500 shows the function calls that occur in the filter memory timer. In one embodiment the timer is set to update once every ten seconds 531. The filter memory timer calls a function that eliminates any market maker memory objects that are no longer active 532.

The table update timer branch 540 of the flowchart 500 shows the function calls that occur in the table update timer. In one embodiment the timer is set to update once every second 541. At a step 542 the table update timer updates the information in the automated trade display window 220 of FIG. 5.

The perform trading algorithm branch 550 illustrated in FIG. 14 is a continuation of the demand timer branch 520 of FIG. 13C, which is in turn a continuation of the data feed flowchart 500 of FIG. 13A. The branch 550 shows the decision logic for simulated and automated trading. The demand timer 521 calls the perform trading branch 550 as represented by perform trading called 550.

Trading and liquidity variables are then calculated 552. The liquidity variables that are collected include: bid volume and bid price and ask volume and ask price for each market maker (and ECN), market maker identification, last trade price and last trade volume. The liquidity variables that are calculated include: bid volume and ask volume per price tier, the statistical bid volume and ask volume per price tier activity summary (for the past thirty minutes, for example) and the statistical bid volume and ask volume for each market maker activity summary (for the past thirty minutes, for example). If the user currently holds a position in a security 553, the program checks to see if market conditions trailing stop, market stop, sell algorithm, and cover algorithm (i.e., the trading variables) are good for exiting the position 554, where the user has established the trading thresholds in the liquidity flow controls of FIG. 3. If the market conditions are good for exiting a position, the program places an exit order 555 to the server or simulates exiting the position when in the simulation mode.

The perform trading algorithm 550 then checks the algorithm table 680 of FIG. 19 (derived from the pattern table 600 of FIG. 17 and the condition table 650 of FIG. 18), which is specific to each security, against the current market conditions to determine whether the user should enter a new position for each security 560. If the algorithm table has a match with current market conditions, a long or short order is placed to the order server. The algorithm table 680 can be manually created by the user. The user automatically creates an element in the algorithm table by highlighting a section of the graphs in FIGS. 8-12 and then right mouse clicking on the “algorithm generator” option. The automated algorithm creation form of FIG. 20 appears in response.

The simulated trading flowchart 580, as illustrated in FIG. 15, shows the decision logic for simulated trading. The simulator begins 581 when the user clicks on the “Run Simulator” 105 button of FIG. 3. User defined variables (as entered in the liquidity control window 99 of FIG. 3) such as symbol, start date, end date, start time, end time, trailing stop loss, and market stop loss are loaded into memory 582. The simulated algorithm then loads the tier files and market maker files into memory for processing 583. The perform trading algorithm 550 is then called to simulate trading based on the current historical data values. Finally, the simulator trading statistics are updated for later analysis 585.

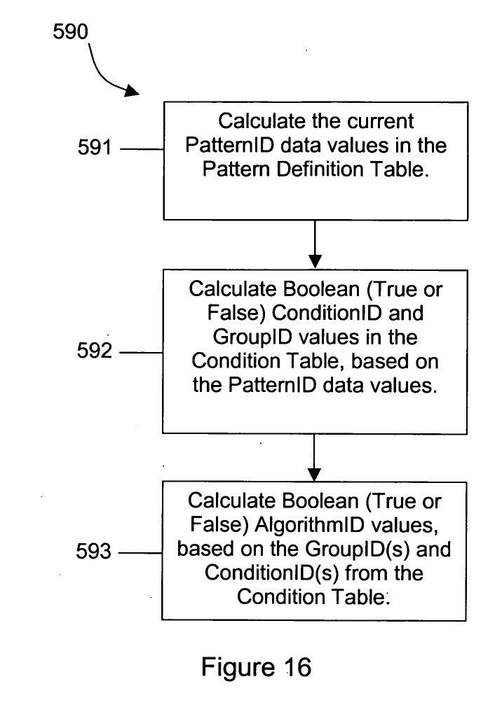

The trading algorithm flowchart 590, as illustrated in FIG. 16, shows how the trading algorithm identifies a pattern in the data. The trading algorithm flowchart is called during simulated trading and during automated trading of FIG. 14. The program first performs the necessary calculations from the pattern definition table 600 of FIG. 17 and updates current PatternID variables 591. Based on the PatternID variables, the program performs the necessary Boolean logic calculations from the condition table 650 of FIG. 18 and updates the current ConditionID and GroupID variables 592. Based on the ConditionID and GroupID variables, the program performs the necessary Boolean logic calculations from the algorithm table 680 and updates the current AlgorithmID variables 593.

The pattern definition table 600, as illustrated in FIG. 17 identifies patterns in the level one, level two and times and sales data. These patterns are used by the flowcharts during simulated trading and actual trading to determine the thresholds for buying and selling securities. The table 600 is broken into user-defined groups based on similar pattern types 601. For example, the patterns that are associated with bid volume per price tier are all listed in the “Bid Tiers” group header 620. The patterns that are associated with the mean last price are all listed in the “Mean Last Price” group header 621.

The “PatternID” column 602, from the pattern definition table 600, is a user-defined name for each specific pattern. Each PatternID is a unique value. The PatternIDs are entered manually by the user at this step 602 or through a graphical user interface.

The “Start Time” column 603 and “End Time” column 604, from the pattern definition table 600, are a user-defined time reference identifying when the pattern begins and ends relative to the current time T. For example, the first pattern 620 listed in the pattern definition table 600 has a start time of “T-60” and an end time of “T”. The “T-60” pattern start time means the pattern began 60 seconds ago. The “T” pattern end time means the pattern ends at time T, which is the current time for the real-time data feed. As another example, the fourth pattern 621 listed in the pattern definition table 600 has a start time of “T-120” and an end time of “T-60”. This means the pattern represents a timeframe from 120 seconds in the past to 60 seconds in the past.

The “Variable” column 605, from the pattern definition table 600, is a user-defined parameter of the pattern data types. The pattern can be based on the volume or price for the bid tiers, the ask tiers, or the last trade data. In one embodiment, the different variables include: bid volume, bid price, ask volume, ask price, last volume, and last price.

The “Price Tier” column 606, from the pattern definition table 600, is a user-defined parameter for the pattern price tier. If the user is defining a pattern based on the last trade price or last trade volume, the price tier will automatically be set to zero. If the user is defining a pattern based on the bid price, ask price, bid volume or ask volume, then the associated price tier is defined in this column. The price tier can be any integer between 0 and 100. For example, if the user wants to define a pattern for the bid volume at the best bid price, then the price tier would be one. If the user wants to define a pattern for the bid volume, at a price one cent below the best bid price, then the tier would be equal to two. As the tier number increase to 20 for example, the bid price tier is 19 cents below the best bid price. The tiers that are closest to the best bid price or best ask price have more influence on the price change than the price tiers further away from the best bid price or best ask price.

The “Operation” column 607, from the pattern definition table 600, is a user-defined mathematical operation that is used to calculate the PatternID value. The mathematical operations include sum, mean, median, max, and min. For example, the first row 620 uses the “Sum” operation, which means that the value for the PatternID is equal to the sum of the first tier bid volumes from 60 seconds in the past to the present.

The “MMID” column 608, from the pattern definition table 600, is a user-defined parameter for the market maker ID. The “MMID” value is used to identify which market makers are included in the PatternID calculations. For example, the first row 620 uses a value of “ALL” for the market maker ID. This means that all market makers and ECNs are included in the calculation for the first tier bid volume. Looking at another example 622, the specific market maker is defined as “NITE”. The value of the PatternID is the sum of the first tier bid volume for the market maker NITE from 60 seconds ago to the present.

The condition table 650, as illustrated in FIG. 18, is used to logically compare multiple PatternIDs created in the pattern definition table 600. Each conditional relationship is given a unique ConditionID 652. Similar ConditionIDs are grouped into a user-defined GroupID 651. The first PatternID is displayed in the third column 653 as “PatternID1.” The second PatternID is displayed in the fifth column 655 as “PatternID2”. The “Logical Condition” 654, defines the relationship between PatternID1 and PatternID2. The “Logical Condition” is a Boolean operator that includes greater than >, greater than or equal >=, less than <, less than or equal <=, and equal =.

The following examples explain the condition table 650 in more detail. The first example looks at the first row 660, which has a GroupID named “VoIPeaks” and a ConditionID named “Peak01”. The “Peak01” condition is true if the “Tier 1, Bid Volume Sum for the past 60 seconds” is greater than “10 times the Tier 1, Ask Volume Sum for the past 60 seconds”.

The next example identifies a rising price condition 661. The GroupID is named “RisingPrice” and the ConditionID is named “UpPrice1”. The “UpPrice1” condition is true if the “Mean Last Trade Price from 60 seconds ago to present” is greater than the “Mean Last Trade Price from 120 seconds ago to 60 seconds ago.”

The algorithm table 680, as illustrated in FIG. 19, is used to logically compare multiple GroupIDs and ConditionIDs created in the condition table 650. Each algorithm relationship is given a unique AlgorithmID 681. The logical operations used to compare the various GroupIDs and ConditionIDs include: AND, OR, and NOT. If the logical combination 683 is determined to be true, then the algorithm will execute the trade as defined in the “Trade Option” 682. The trade option can be “Buy Long”, “Sell Long”, “Sell Short”, or “Cover Short”.

The following examples explain the algorithm table 680 in greater detail. The first example looks at the first row 690, which has an AlgorithmID named “A1”. The “A1” algorithm condition is true if the ConditionIDs “Peak01” and “UpPrice2” are both true at this instant in time.

The next algorithm that is reviewed from the Algorithm Table 680 is named “A3” 691. This algorithm shows the combination of GroupIDs with ConditionIDs. The GroupID named “VoIPeaks” from the condition table 650 is true if all of the ConditionIDs in the “VoIPeaks” Group are true. This means that “Peak01”, “Peak02”, “Peak03”, “Peak04”, “Peak05”, and “Peak06” all need to be true. The AlgorithmID “A3” is true if the “VoIPeaks” GroupID and the “UpPrice2” ConditionID are both true at this instance in time.

The trading algorithm, as illustrated in FIG. 16, is based on the logical combination of the Pattern Table, the Condition Table, and the Algorithm Table. See the step 593 of FIG. 16. This logic-based algorithm provides the user with flexibility to track and trade based on a variety of trading variables and timeframes as specified by the user.

While the user has the ability to manually enter the patterns into the tables of FIGS. 17, 18 and 19, according to another embodiment an automatic methodology is provided to improve efficiency and reduce errors in entering the PatternIDs, ConditionIDs, and AlgorithmIDs. The automatic algorithm generator is illustrated in FIG. 20. The user first highlights a section of the graphs in FIGS. 8-12 and then right mouse clicks on the Algorithm Generator option. In response, the algorithm generator creates FIGS. 17-19 based on previously established user thresholds and tolerances. A window form 700 with a list of highlighted variables is displayed, as illustrated in FIG. 20. The form includes a start time 701 that defines the beginning time desired for the algorithm pattern analysis. The form also includes an end time 702 that defines the ending time of the algorithm pattern analysis.

As part of the automated algorithm creation form 700, the patterns may need to be converted into a more discrete waveform. The “Resolution Window” 703 is a user-defined period of time indicating the resolution of the waveform.

As part of the automated algorithm creation form 700, the required level of correlation between the AlgorithmID pattern and the real-time data stream pattern is defined by the variable “Correlation Factor” 704. A correlation value of one means that the two patterns need to be exactly the same. A correlation value of 0.9 means that for each resolution window, the two patterns need to be 90 percent correlated, or within a 10 percent of each other.

As part of the automated algorithm creation form 700, the user has the option to define the name for the AlgorithmID 705. The PatternIDs and ConditionIDs are automatically named while using the automated algorithm creation.

As part of the automated algorithm creation form 700, the user has the option to enable or disable each variable that is present from the highlighted chart. The user clicks on the enabled 710 checkbox to enable a specific variable. The user clicks on the enabled 710 checkbox again to disable a specific variable.

As part of the automated algorithm creation form 700, the variable type is automatically listed. Variables can include bid volume, ask volume, trade volume, bid price, ask price, and last trade price.

As part of the automated algorithm creation form 700, the user has the option to define how the pattern is recognized by selecting the “Relative or Absolute” 712 option. If the user selects the “Relative” data option, the algorithm is created using relative values, which are based on the relative change from the previous value in the pattern. For price changes, the relative change is the difference from the first resolution window to the next resolution window. For volume changes, the relative change is the percentage change from the first resolution window to the next resolution window. If the user selects the “Absolute” data option, then the algorithm will be created using the raw data values, such as $39.34, as the absolute last trade price.

As part of the automated algorithm creation form 700, the user has the option to define how the pattern is computed by selecting the “Operation” 713 option. The operation defines how the data values are combined within each resolution window. Typically, the mean value is adequate for all algorithms. The user does have the option to use the mean, median, max, or min for the resolution window variable value.

As part of the automated algorithm creation form 700, the program automatically includes the tier value for each bid volume and ask volume. A tier value of one for bid volume is equal to the volume at the best bid volume.

According to another embodiment of the invention, a neural network is employed to perform more complicated data analyses and pattern comparisons to determine the existence of a trade imbalance. Such a neural network can also optimize the patterns and parameters based on historical data.

An architecture, process and computer system have been described as useful for securities liquidity flow analysis and securities trading. Specific applications and exemplary embodiments of the invention that provide a basis for practicing the invention in a variety of ways and in a variety of circuit structures have been illustrated and discussed. Numerous variations are possible within the scope of the invention. Features and elements associated with one or more of the described embodiments are not to be construed as required elements for all embodiments. The invention is limited only by the claims that follow.

What is claimed is:

1. A method for performing liquidity flow analysis for a security comprising:
receiving trading data associated with the security, wherein the trading data comprises trading data for a plurality of buyers and sellers;
defining display parameters for the trading data;
displaying elements of the trading data in accordance with the defined display parameters;
defining analysis parameters for the trading data;
aggregating the trading data for the plurality of buyers and sellers for the security; and
analyzing the trading data according to the analysis parameters to determine whether the security exhibits a liquidity flow imbalance.

2. The method of claim 1 further comprising simulating a security trade in response to one of or both of user selected thresholds and patterns in the trading data as determined during the step of analyzing.

3. The method of claim 1 further comprising trading the security in response to one or both of user selected thresholds and patterns in the trading data as determined during the step of analyzing.

4. The method of claim 1 wherein the step of receiving securities trading data further comprises receiving dynamically-updated trading data for a plurality of securities for a plurality of market makers and ECN'S, and wherein the securities data comprises at least one of level one data, level two data or time and sales data.

5. The method of claim 4 wherein the level one data comprises one or more of a last trade price, a best bid price, a best ask price and a security identifier associated with each price, and wherein the level two data comprises one or more of bid prices, bid times, bid volumes, a security identifier associated with each bid, a market maker identifier associated with each bid, an ask price, an ask time, an ask volume, a security identifier associated with each ask and a market maker identifier associated with each ask.

6. The method of claim 4 wherein the step of analyzing further comprises determining a relationship between level two data and subsequent price activity for the security.

7. The method of claim 6 wherein the relationship is determined with respect to time.

8. The method of claim 7 wherein the step of displaying further comprises displaying the relationship between the level two data and subsequent security price activity with time.

9. The method of claim 4 wherein the step of analyzing further comprises analyzing short and long term upward and downward trends in the level two data.

10. The method of claim 1 wherein the trading data comprises bid prices, a bid volume associated with each bid price and a market maker identifier associated with each bid price, an ask prices, an ask volume associated with each ask price, a security identifier associated with each ask price and a market maker identifier associated with each ask price, and wherein the step of displaying further comprises displaying data for the security, wherein the data comprises bid prices and an associated bid volume and the market maker identifier for each bid price and ask prices and an associated ask volume and the market maker identifier for each ask price.

11. The method of claim 10 wherein the data further comprises bid prices and ask prices grouped within one of a plurality of bid price tiers and ask price tiers, respectively.

12. The method of claim 10 wherein the bid prices and the bid volumes comprise bid prices and bid volumes at a predetermined time, an average of bid prices and bid volumes over a time interval or a moving average of bid prices and bid volumes, and wherein the ask prices and the ask volumes comprise ask prices and ask volumes at a predetermined time, an average of ask prices and ask volumes over a time interval or a moving average of ask prices and ask volumes.

13. The method of claim 1 further comprising displaying for a market maker or an ECN and the security, bid prices within one of a plurality of bid price tiers and a corresponding bid volume for each of the plurality of bid price tiers at predetermined historical times and displaying for a market maker or an ECN and the security, ask prices within one of a plurality of ask price tiers and a corresponding ask volume for each of the plurality of ask price tiers at predetermined historical times.

14. The method of claim 1 further comprising identifying a liquidity trade imbalance and a security price reaction in response thereto over a time interval.

15. The method of claim 1 wherein the step of displaying further comprises displaying the trading data on a tier basis for a bid price and an ask price, and wherein a first price tier comprises a best bid price and a best ask price, and wherein a second price tier comprises a price an increment below the best bid price and an increment above the best ask price.

16. The method of claim 1 wherein the step of analyzing further comprises analyzing market maker and ECN'S bids and asks over a plurality of time windows for isolating short and long term trading patterns.

17. The method of claim 1 further comprising specifying patterns for at least one of level one data, level two data or time and sales data and executing a security transaction in response to an appearance of one of the patterns in the level one data, the level two data and the time and sales data.

18. The method of claim 17 wherein the patterns relate to a bid volume for one or more of a plurality of bid price tiers, an ask volume for one or more of a plurality of ask price tiers or a trade price, wherein the patterns are determined during a predetermined time interval further comprising an instant in time or an average over the predetermined time interval.

19. The method of claim 17 wherein a pattern is deemed to appear in one of the level one data, the level two data or the time and sales data when a difference between the pattern and the level one data, the level two data or the time and sales data, is within a predetermined correlation factor.

20. The method of claim 1 wherein the step of displaying further comprises displaying elements of the trading data from which a liquidity imbalance in a security can be identified.

21. The method of claim 1 wherein the step of defining analysis parameters further comprises identifying a plurality of patterns for the trading data and a plurality of conditions, and wherein each one of the plurality of conditions comprises one or more of the plurality of patterns, and wherein the step of analyzing the trading data further comprises determining whether the trading data satisfies one or more of the conditions.

22. The method of claim 21 wherein the step of determining further comprises determining whether the trading data satisfies a conditional combination comprising at least two conditions combined according to a logical or a Boolean operation.

23. The method of claim 1 wherein the step of defining analysis parameters further comprises defining a plurality of thresholds for the trading data, and wherein the step of analyzing the trading data further comprises determining a relationship between the trading data and one or more of the plurality of thresholds, the method further comprising executing a security transaction in response to the relationship.

24. The method of claim 23 wherein the step of defining the plurality of thresholds further comprises a user defining the plurality of thresholds.

25. The method of claim 1 wherein the step of displaying further comprises displaying for the security for a time interval, a bid volume for each one of a plurality of bid price tiers, an ask volume for each one of a plurality of ask price tiers, trade price and trade volume.

26. The method of claim 25 wherein the bid volume for each one of the plurality of bid price tiers and the ask volume for each one of the plurality of ask price tiers comprises bid volume for each one of the plurality of bid price tiers and ask volume for each one of the plurality of ask price tiers for a single market maker or fro a plurality of market makers.

27. The method of claim 1 wherein the trading data comprises for the security, bid volume data for each one of a plurality of bid price tiers and ask volume data for each one of a plurality of ask price tiers, and wherein the step of analyzing further comprises comparing the trading data to time and sales data.

28. The method of claim 1 wherein the trading data comprises for the security and for a plurality of market makers or ECN'S, bid volume for each one of a plurality of bid price tiers and ask volume for each one of a plurality of ask price tiers, and further comprises trade price and trade volume, and wherein the step of analyzing further comprises determining a relationship among bid volume for each one of the plurality of bid price tiers, ask volume for each one of the plurality of ask price tiers, trade volume and trade prices.

29. The method of claim 28 wherein the relationship is determined at a predetermined time or is determined by averaging over a predetermined time interval.

30. The method of claim 1 wherein the trading data comprises bid volume and bid price and ask volume and ask price for each market maker and for each ECN, a market maker identifier and a last trade price and last trade volume.

31. The method of claim 1 further comprising determining liquidity variables comprising one or more of a bid volume and an ask volume per price tier, statistical measures representing the bid volume and the ask volume per price tier over a predetermined time interval, or statistical measures representing the bid volume and the ask volume for each market maker over a predetermined time interval.

32. The method of claim 1 further comprising executing a buy transaction for the security at a best ask price in response to the step of analyzing determining a liquidity flow imbalance for the security.

33. The method of claim 1 further comprising executing a sell transaction for the security in response to the step of analyzing.

34. The method of claim 1 wherein the trading data comprises for the security and for a plurality of market makers over a predetermined time interval, bid prices and an associated bid volume and ask prices and an associated ask price volume, and wherein the step of analyzing further comprises:
determining bid price tiers and ask price tiers;
assigning each bid price to an appropriate bid price tier;
assigning each ask price to an appropriate ask price tier;
determining a relationship among bid volume for each one of the bid price tiers and the ask volume for each one of the ask price tiers to determine whether the security exhibits a liquidity trade imbalance.

35. The method of claim 34 wherein the trading data further comprises for the security and for a plurality of market makers over a predetermined time interval trade volume and trade prices, and wherein the step of determining the relationship further comprises determining the relationship among bid volume for each one of the bid price tiers, the ask volume for each one of the ask price tiers, the trade volume and the trade prices to determine whether the security exhibits a liquidity trade imbalance.

36. A method for performing liquidity flow analysis for a security comprising:
receiving trading data associated with the security, wherein the trading data comprises over a predetermined time interval, bid prices and an associated bid volume and ask prices and an associated ask price volume;
assigning each bid price to an appropriate bid price tier from among a plurality of bid price tiers;
assigning each ask price to an appropriate ask price tier from among a plurality of ask price tiers;
displaying a plurality of first elements each representing one of the plurality of bid price tiers and a bid price volume associated therewith;
displaying a plurality of second elements each representing one of the plurality of ask price tiers and an ask price volume associated therewith;
analyzing the bid price volume for each one of the plurality of bid price tiers and the ask price volume for each one of the plurality of ask price tiers to determine whether the security exhibits a liquidity trade imbalance.

37. The method of claim 36 wherein the steps of displaying the plurality of first elements, displaying the plurality of second elements and analyzing, are executed for a single market maker or a single ECN.

38. The method of claim 36 wherein the steps of displaying the plurality of first elements, displaying the plurality of second elements and analyzing, are executed for a plurality of market makers, a plurality of ECN'S or a combination of market makers and ECN'S.

39. The method of claim 36 further comprising executing a security transaction in response to the analyzing step further comprising determining a relationship between the bid price volume for each one of the plurality of bid price tiers and the ask price volume for each one of the plurality of ask price tiers, and a user-defined threshold parameter.

40. The method of claim 36 further comprising executing a security transaction in response to the analyzing step further comprising determining whether the bid price volume for each one of the plurality of bid price tiers and the ask price volume for each one of the plurality of ask price tiers satisfies user-defined trading conditions.

41. The method of claim 36 wherein the trading data comprises at least one of level one data, level two data or time and sales data received over time, the method further comprising determining a time interval since receiving the previous at least one of the level one data, the level two data or the time and sales data.

42. The method of claim 36 wherein the trading data comprises level one data, level two data and time and sales data all associated with security trades from a plurality of security exchanges, wherein a subset of the plurality of security exchanges provide level two data, the method further comprising determining a number of security trades occurring on the subset as a percent of the number of security trades occurring on the plurality of security exchanges.

43. A computer program product for performing liquidity flow analysis for a security, the computer program comprising:
a computer usable medium having computer readable program code modules embodied in the medium for performing the liquidity flow analysis;
a computer readable first program code module for receiving trading data associated with the security wherein the trading data comprises over a predetermined time interval, bid prices and an associated bid volume and ask prices and an associated ask price volume;
a computer readable second program code module for assigning each bid price to an appropriate bid price tier from among a plurality of bid price tiers;
a computer readable third program code module for assigning each ask price to an appropriate ask price tier from among a plurality of ask price tiers;
a computer readable fourth program code module for displaying a plurality of first elements each representing one of the plurality of bid price tiers and a bid price volume associated therewith;
a compute readable fifth program code module for displaying a plurality of second elements each representing one of the plurality of ask price tiers and an ask price volume associated therewith; and
a computer readable sixth program code module for analyzing the bid price volume for each one of the plurality of bid price tiers and the ask price volume for each one of the plurality of ask price tiers to determine whether the security exhibits a liquidity trade imbalance.
